(19) United States
(12) Patent Application Publication
(10) Pub. No.: US 2008/0117474 A1
(43) Pub. Date: May 22, 2008

(54) DATA COMMUNICATION APPARATUS AND DATA COMMUNICATION METHOD

(75) Inventor: Shigeo Miura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/941,542

(22) Filed: Nov. 16, 2007

(30) Foreign Application Priority Data
Nov. 22, 2006 (JP) 2006-315449

(51) Int. Cl. H04N 1/00

(52) U.S. Cl. 358/425

(57) ABSTRACT

In a data communication apparatus that performs voice communication and facsimile communication in parallel via the Internet, whether voice data is to be preferentially processed is decided by determining a processing state of the voice data about voice communication with another apparatus or facsimile data about facsimile communication with another apparatus, the voice data and the facsimile data being stored in a buffer of the data communication apparatus, and the voice data stored in the buffer is preferentially processed while maintaining the facsimile communication if it is decided to preferentially process the voice data.

### BACKGROUND OF THE INVENTION

1. Field of the Invention

The present invention relates to a communication process in a data communication apparatus capable of performing image data communication and voice data communication in parallel.

2. Description of the Related Art

Hitherto, an IP (Internet Protocol) communication system capable of transmitting/receiving voice data and image data by using packet communication via the Internet (IP communication network) based on an Internet-related technique has been suggested.

Japanese Patent Laid-Open No. 2004-96326 describes a technique of, under an H.323 environment where a voice data session and a facsimile data session in an IP communication network are simultaneously established, appropriately switching between the sessions.

Japanese Patent Laid-Open No. 6-14151 describes a system of intentionally degrading communication quality in videophone in order to reduce a telecommunication fee. In this system, data communication is performed in accordance with the order of priority of voice data and video data.

FIG. 34 illustrates an entire configuration of an IP phone system of this type. Hereinafter, a factor of deterioration of voice in IP phone communication is described with reference to FIG. 34. In FIG. 34, reference numeral 3 denotes an Internet protocol network (IP network), which connects to IP phones 1 and 5 via routers 2 and 4 such that the IP phones 1 and 5 can communicate with each other. Also, the IP network 3 connects to analog phones 6 and 11 via routers 8 and 9 and VOIP (Voice over IP) gateways 7 and 10 such that the analog phones 6 and 11 can communicate with each other. The analog phones 6 and 11 can communicate with each other also via a public telephone line (PSTN: Public Switched Telephone Network).

In the IP phone system having the configuration illustrated in FIG. 34, transmission delay may occur in the network. More specifically, internal delay occurs in data communication because communication is performed via the routers 2 and 4 or 8 and 9. That is, delay occurs in a queuing process described below.

Also, in a call receiving process between the VOIP gateways 7 and 10 or between the IP phones 1 and 5, delay occurs in voice decoding or in a jitter absorbing buffer.

Now, a difference between priority control on the network side and priority control of voice data on the terminal side is described. In the priority control on the network side, input packets are analyzed and are input to queues based on priority. The input packets are not denied. This is illustrated in FIG. 35.

FIG. 35 is a block diagram illustrating a queue function of the routers 2, 4, 8, and 9 illustrated in FIG. 34. In the priority control on the network side, elements required for the priority control exist in the router or switch. Hereinafter, these elements are described.

Referring to FIG. 35, queues 22 to 25 hold voice data. The queue 22 holds voice data 26 to 28. The queue 23 holds voice data 29. The queue 24 holds voice data 30. The queue 25 holds voice data 31. Also, a packet input interface 21 and an output interface 32 are provided.

As illustrated in FIG. 35, the routers 2, 4, 8, and 9 include a packet identifying unit to identify each input packet, a plurality of queues, and a unit to supply input packets to the respective queues with reference to an identification result made by the packet identifying unit.

The routers 2, 4, 8, and 9 include the queues 22 to 25. Here, priorities 1 to 4 are assigned to the queues 22 to 25 in this order. A queue is necessary for each priority. Also, a queuing algorithm and a method for outputting packets supplied to the queues 22 to 25 are necessary.

Furthermore, the router or LAN (Local Area Network) switch having the priority control may include a unit to place priority on a voice packet even by discarding a previously-arrived WEB access packet.

However, as in the queue 22 illustrated in FIG. 35, when a plurality of pieces of voice data 26 to 28 of the same order of priority are accumulated in a queue, delay of data transmission or discard of data is likely to occur. Such delay or discard occurs at a point of dense traffic on the network side. Output is restricted by many inputs from interface at this point, and thus priority control has limitations.

FIG. 36 illustrates a network layer of the VOIP gateway 7 illustrates in FIG. 34. Referring to FIG. 36, a COS field is used to identify a voice packet in a field 72 of a layer 71. The COS is an abbreviation of “Class Of Service”. It is formally called “user priority” and is data of three bits. As the value of COS is larger, the order of priority is higher.

In a field 74 of a layer 73, TOS (Type Of Service) is used to distinguish voice from data by an IP address. In an IP presence field defined by RFC (Request For Comments) 1349, high three bits are used as a field to indicate priority. In a DSCP (Differentiated Services Code Point) defined by RFC2474, high six bits in the TOS field are used as a field to indicate priority.

In a field 76 of a layer 75, a port number of TCP (Transmission Control Protocol) and UDP (User Datagram Protocol) is used. A representative application can be specified by this field 76. That is, when the port number is 5060, which corresponds to SIP (Session Initiation Protocol), a control signal of IP telephony can be preferentially processed. Note that high priority needs to be placed on an RTP (Real-time Transport Protocol) packet in IP telephony, but that a port number of UDP is dynamically assigned to each voice communication. Thus, the process is difficult.

The jitter absorbing buffer is described next. In the IP phone 1 or the VOIP gateway 7, the jitter absorbing buffer to absorb jitter of reception data is required.

In the data communication apparatus illustrated in FIG. 34, the IP phone on the receiver side is provided with a jitter absorbing buffer. In analog telephony, the jitter absorbing buffer exists in a gateway. The jitter absorbing buffer temporarily accumulates received voice packets and corrects irregular intervals of the packets to regular intervals. With reference to a time stamp of an RTP header, the packets are converted to analog signals at original packet intervals.

In this way, the jitter absorbing buffer statistically calculates the intervals of reception packets and counts the number of packets to be dynamically buffered based on a calculation result. If a state of large jitter continues, delay that occurs in the buffer becomes large. If a large jitter uncontrollable for the buffer occurs, the packet is discarded.

Typically, a buffer of about 100 ms is prepared. In the example illustrated in FIG. 34, the VOIP gateway 7 transmits data to the analog phone 6 when all packets are prepared. After 100 ms have elapsed, the packets are discarded. When the capacity of the buffer is large, discarded packets are reduced. In that case, however, long delay occurs and a sense of discomfort becomes significant.

According to the standard of IP telephony, total delay time is required to be 150 ms or less. Thus, if a delay of 100 ms occurs in the jitter absorbing buffer, the delay in the other part needs to be suppressed to 50 ms or less. Voice data is transmitted at intervals of 20 ms. Thus, a delay of 20 ms at the maximum occurs here. In view of this delay, the delay in the other part needs to be suppressed to 30 ms or less. In this case, data is discarded after 30 ms have elapsed, causing skip of voice.

The data communication apparatus according to the related art has the above-described configuration. Particularly, when voice data communication (IP telephony) and facsimile data communication (T.38) are simultaneously performed, a state where voice data communication cannot normally be performed occurs due to an increase in data processing load. T.38 indicates real-time Internet facsimile communication according to ITU-T (International Telecommunication Union Telecommunication Standardization Sector) recommendation T.38.

### SUMMARY OF THE INVENTION

The present invention provides a system capable of preferentially perform voice data communication when voice data communication and facsimile data communication are performed in parallel.

According to an aspect of the present invention, a data communication apparatus that performs voice communication and facsimile communication in parallel via the Internet includes a buffer configured to store voice data about voice communication with another apparatus or facsimile data about facsimile communication with another apparatus, wherein the voice data and the facsimile data are transmitted or received via the Internet, a deciding unit configured to determine whether the voice data is to be preferentially processed by determining a processing state of the voice data or the facsimile data stored in the buffer, and a communication control unit configured to preferentially process the voice data stored in the buffer while maintaining the facsimile communication if the deciding unit determines to preferentially process the voice data stored in the buffer.

Further features of the present invention will become apparent from the following detailed description of exemplary embodiments with reference to the attached drawings.

### BRIEF DESCRIPTION OF THE DRAWINGS

FIG. 1 is a block diagram illustrating a configuration of a multifunction peripheral to which a data communication apparatus according to a first exemplary embodiment of the present invention is applied.

FIG. 2 is a block diagram illustrating a configuration of a data communication control unit of an image forming apparatus to which the data communication apparatus according to the first exemplary embodiment is applied.

FIG. 3 is a block diagram illustrating a state of a transmission buffer of the data communication apparatus illustrated in FIG. 1.

FIG. 4 is a block diagram illustrating a configuration of a transmission buffer and a reception buffer of the data communication apparatus illustrated in FIG. 1.

FIG. 5 is a block diagram illustrating an example of a network system to which the data communication apparatus according to the first exemplary embodiment is applied.

FIG. 6 is a flowchart illustrating an example of a first data communication process performed in the data communication apparatus according to the first exemplary embodiment.

FIG. 7 is a block diagram illustrating a state of a reception buffer of a data communication apparatus according to a second exemplary embodiment of the present invention.

FIG. 8 is a flowchart illustrating an example of a second data communication process performed in the data communication apparatus according to the second exemplary embodiment.

FIG. 9 is a block diagram illustrating an example of an image forming apparatus to which a data communication apparatus according to a third exemplary embodiment of the present invention can be applied.

FIG. 10 illustrates a flow of data from a transmission buffer memory provided in an SDRAM illustrated in FIG. 9 to a PHY.

FIG. 11 illustrates a flow of data from the PHY illustrated in FIG. 10 to a reception buffer memory.

FIG. 12 is a block diagram illustrating a multitask process performed by the data communication apparatus illustrated in FIG. 9.

FIG. 13 is a flowchart illustrating an example of a third data communication process performed in the data communication apparatus according to the third exemplary embodiment.

FIG. 14 is a block diagram illustrating a configuration of a main part of a data communication apparatus according to an exemplary embodiment of the present invention.

FIG. 15 is a flowchart illustrating an example of a fourth data communication process performed in the data communication apparatus according to an exemplary embodiment of the present invention.

FIG. 16 is a block diagram illustrating a configuration of a main part of a data communication apparatus according to an exemplary embodiment of the present invention.

FIG. 17 is a flowchart illustrating an example of a fifth data communication process performed in the data communication apparatus according to an exemplary embodiment of the present invention.

FIG. 18 is a flowchart illustrating an example of a sixth data communication process performed in a data communication apparatus according to an exemplary embodiment of the present invention.

FIG. 19 is a block diagram illustrating a configuration of a main part of a data communication apparatus according to an exemplary embodiment of the present invention.

FIG. 20 illustrates an operation of a PPR output unit of a data communication apparatus according to an exemplary embodiment of the present invention.

FIG. 21 is a flowchart illustrating an example of a seventh data communication process performed in the data communication apparatus according to an exemplary embodiment of the present invention.

FIG. 22 is a block diagram illustrating a configuration of a main part of a data communication apparatus according to an exemplary embodiment of the present invention.

FIG. 23 is a block diagram illustrating a specific configuration of an entire reception buffer including a reception buffer illustrated in FIG. 22.

FIG. 24 is a flowchart illustrating an example of an eighth data communication process performed in a data communication apparatus according to an exemplary embodiment of the present invention.

FIG. 25 is a block diagram illustrating a configuration of a main part of a data communication apparatus according to an exemplary embodiment of the present invention.

FIG. 26 is a block diagram illustrating a configuration of a main part of a data communication apparatus according to an exemplary embodiment of the present invention.

FIG. 27 is a flowchart illustrating an example of a ninth data communication process performed in a data communication apparatus according to an exemplary embodiment of the present invention.

FIG. 28 is a flowchart illustrating an example of a tenth data communication process performed in a data communication apparatus according to an exemplary embodiment of the present invention.

FIG. 29 is a flowchart illustrating an example of an eleventh data communication process performed in the data communication apparatus according to an exemplary embodiment of the present invention.

FIG. 30 is a flowchart illustrating an example of a twelfth data communication process performed in the data communication apparatus according to an exemplary embodiment of the present invention.

FIG. 31 is a flowchart illustrating an example of a thirteenth data communication process performed in the data communication apparatus according to an exemplary embodiment of the present invention.

FIG. 32 is a flowchart illustrating an example of a fourteenth data communication process performed in the data communication apparatus according to an exemplary embodiment of the present invention.

FIG. 33 illustrates a memory map of a storage medium to store various data processing programs that can be read by the data communication apparatus according to an exemplary embodiment of the present invention.

FIG. 34 illustrates an entire configuration of an IP phone system according to a related art.

FIG. 35 is a block diagram illustrating a queue function of a router illustrated in FIG. 34.

FIG. 36 illustrates a network layer of a VOIP gateway 7 illustrated in FIG. 34.

### DESCRIPTION OF THE EMBODIMENTS

Hereinafter, exemplary embodiments of the present invention are described with reference to the drawings.

### <Description of System Configuration>

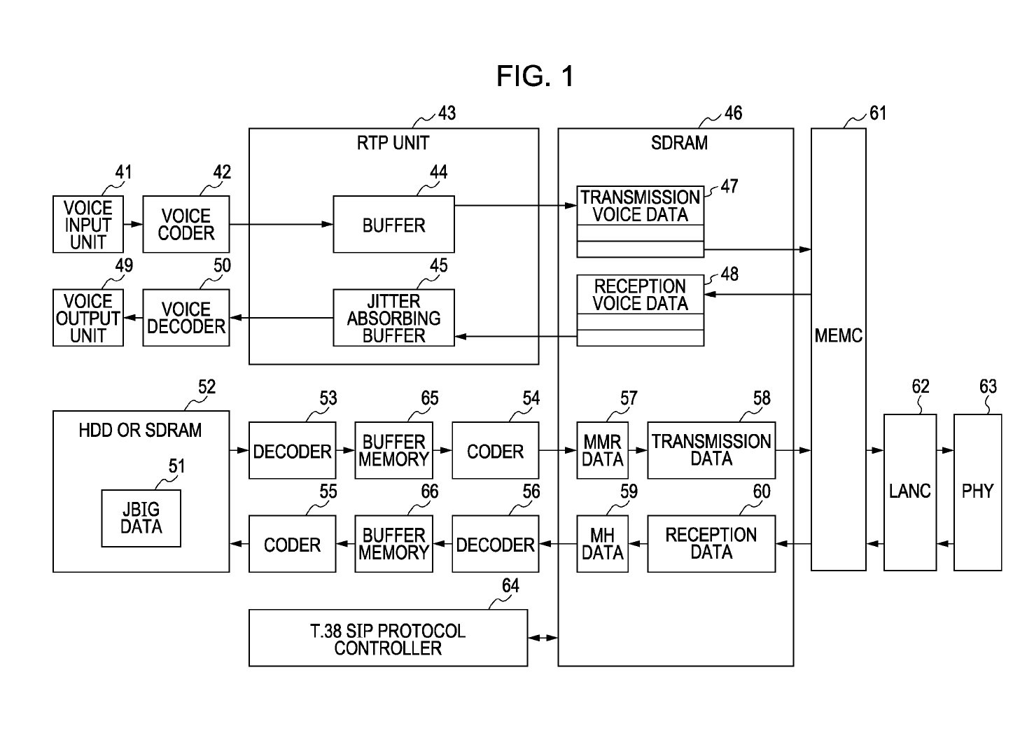

FIG. 1 is a block diagram illustrating a configuration of an MFP (MultiFunction Peripheral) to which a data communication apparatus according to a first exemplary embodiment of the present invention is applied. The data communication apparatus according to the present embodiment includes a function of performing voice data communication and facsimile data communication in parallel via an IP (Internet Protocol) network. In the present embodiment, the facsimile data communication is performed based on the T.38 protocol, but is not limited to this protocol. The facsimile data communication based on the T.38 protocol includes communication with a G3 facsimile apparatus via a gateway (not shown).

Referring to FIG. 1, a voice input unit 41 is used to input voice and includes a handset or a microphone. The input voice data is encoded before being transmitted to the IP network in a form of packet.

A voice coder 42 converts input voice to coded voice data of G.711, etc. An RTP (Real-time Transport Protocol) unit 43 adds or analyzes RTP. A buffer 44 temporarily accumulates coded data from the voice coder 42 and transmits the data to an SDRAM (Synchronous Dynamic Random Access Memory) 46 by adding RTP thereto.

A jitter absorbing buffer 45 sorts pieces of coded voice data added with RTP information from a communication apparatus on the other end, and transmits the coded voice data to a voice decoder 50. The jitter absorbing buffer 45 is not necessarily provided. In that case, communication data is stored in a reception buffer of the SDRAM 46.

The SDRAM 46 accumulates data to be transmitted to a memory controller (MEMC) 61 or data from the memory controller 61. The SDRAM 46 may be a single SDRAM or may be a memory of higher throughput, such as DDR (Double Data Rate) or DDR2.

The SDRAM 46 adopts clock-synchronization input/output, where input/output of a command or data is performed in synchronization with a clock signal, and thus signals other than the clock signal need not be considered. The performance of memory access depends on the frequency of the clock signal. Furthermore, burst transfer can be performed in access of the SDRAM 46. For example, after a start address has been given by a read/write command, the address is automatically incremented and data is continuously output so that the load of a bus reduces. Accordingly, data transfer of higher speed can be realized.

Here, an operation is controlled by various commands based on a combination of three types of signals RAS (Row Address Strobe), CAS (Column Address Strobe), and WE (Write Enable) and selection of CS (Control Systems) and CSE (Control Systems Engineering). An independent bank structure can also be used. The independent bank structure behaves as if a plurality of DRAMs exist therein.

A transmission voice data group 47 is accumulated in the SDRAM 46 and is transmitted to the network. A reception voice data group 48 is data received from the network and is accumulated in the SDRAM 46.

A voice output unit 49 includes a handset or a speaker. The voice decoder 50 decodes coded voice data of G.711, etc.

JBIG (Joint Bi-level Image Experts Group) data 51 is stored in an image memory 52. The image memory 52 includes a hard disk or a semiconductor memory such as an SDRAM.

A decoder 53 decodes the JBIG data 51 to RAW data or intermediate data. A coder 54 codes image data in accordance with a coding method of a facsimile apparatus on the other end, for example, MMR (Modified Modified Read).

A coder 55 codes image data in accordance with a memory accumulating method of the own apparatus, for example, to JBIG data. A decoder 56 decodes image data that is MH (Modified Huffman)-coded from the facsimile apparatus on the transmitter side. MMR data 57 is transmission data based on a coding method in the facsimile apparatus on the receiver side. Transmission data 58 is MMR data 57 added with various headers to transmit image data to the apparatus on the receiver side via the network. MH data 59 is image data received from the apparatus on the other end. Reception data 60 is image data added with various headers.

The memory controller (MEMC) 61 controls memory access of the SDRAM 46. If an SDRAM is used as the image memory 52, access thereof can be controlled by the MEMC 61. Also, if the buffer 44, the jitter absorbing buffer 45, and buffer memories 65 and 66 are stored in the SDRAM 46, the MEMC 61 can control access to these memory resources. The image memory 52, the buffer 44, the jitter absorbing buffer 45, and the buffer memories 65 and 66 may be physically integrated into a single unit. The memory used for a plurality of functions operates based on an occupancy rate of a bus of another function or an effect of the MEMC 61, that is, in accordance with clocks of the SDRAM 46.

A network controller (LANC) 62 transmits packets to the network or receives packets from the network and controls network access.

A PHY 63 controls a physical layer of the network. A protocol controller 64 controls protocols of SIP (Session Initiation Protocol) and T.38. The buffer memory 65 temporarily accumulates data once decoded in the decoder 53. The buffer memory 66 temporarily accumulates data one decoded in the decoder 56.

The coders 54 and 55 and the decoders 53 and 56 can be a hard codec on the transmitter side and a soft codec on the receiver side, or a soft codec on both transmitter and receiver sides. In this way, the codec varies (soft or hard) depending on an apparatus. If a soft codec is used, a load of a CPU (Central Processing Unit) is heavy particularly in multiplex processing.

In the data communication apparatus having the above-described configuration, the jitter absorbing buffer 45 functions as a device to absorb jitter of reception data. Also, the data communication apparatus is capable of coding voice signals and transmitting coded voice data to an apparatus on the other end via the network, so that the apparatus on the other end can reproduce the data in real time. Also, the data communication apparatus receives coded voice data from the apparatus on the other end via the network and reproduces the data in real time. Furthermore, the data communication apparatus can perform facsimile communication via the network at the same time as communication of the coded voice data.

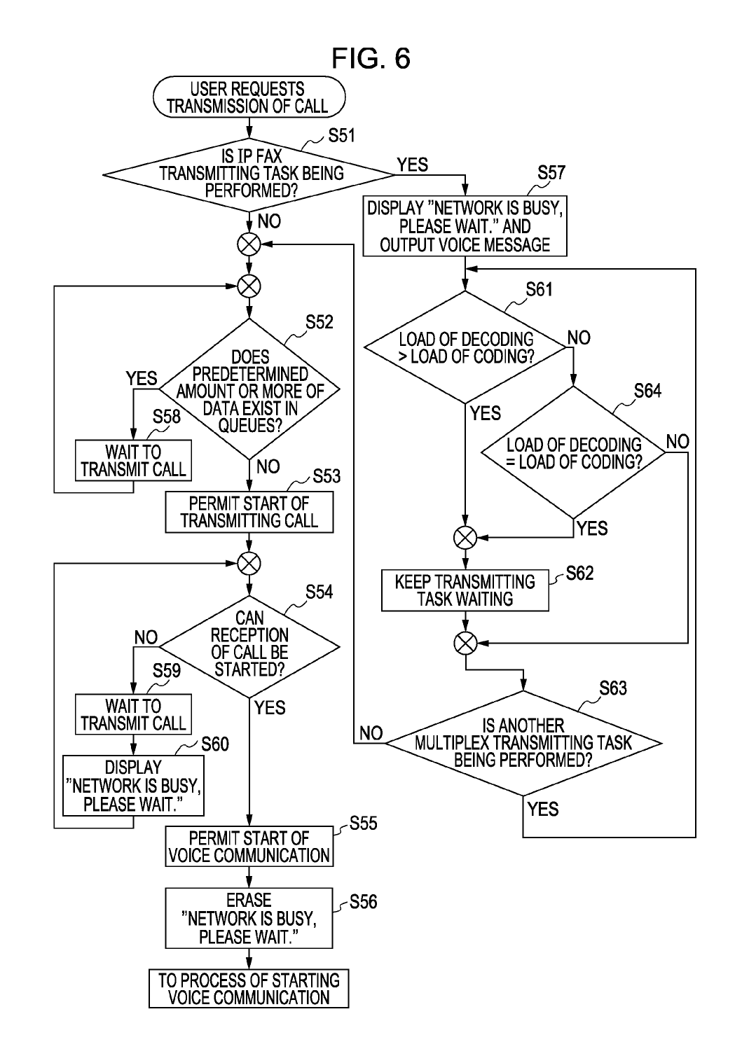

In the above-described communication, the following state occurs, that is, a state where data to be transmitted by facsimile is accumulated as a queue in a memory for transmitting the data to the network. Under this state, if the coded voice data cannot be transmitted to the network at regular intervals, control is performed so that coding of the voice signals and an operation of transferring the voice data to the memory for transmitting it to the network are not started. This control is described below with reference to the flowchart illustrated in FIG. 6.

In the data communication apparatus according to this embodiment, SIP is used as a communication protocol via the network. Also, ITU-T (International Telecommunication Union Telecommunication Standardization Sector) T.38 can be used as a protocol of facsimile transmission.

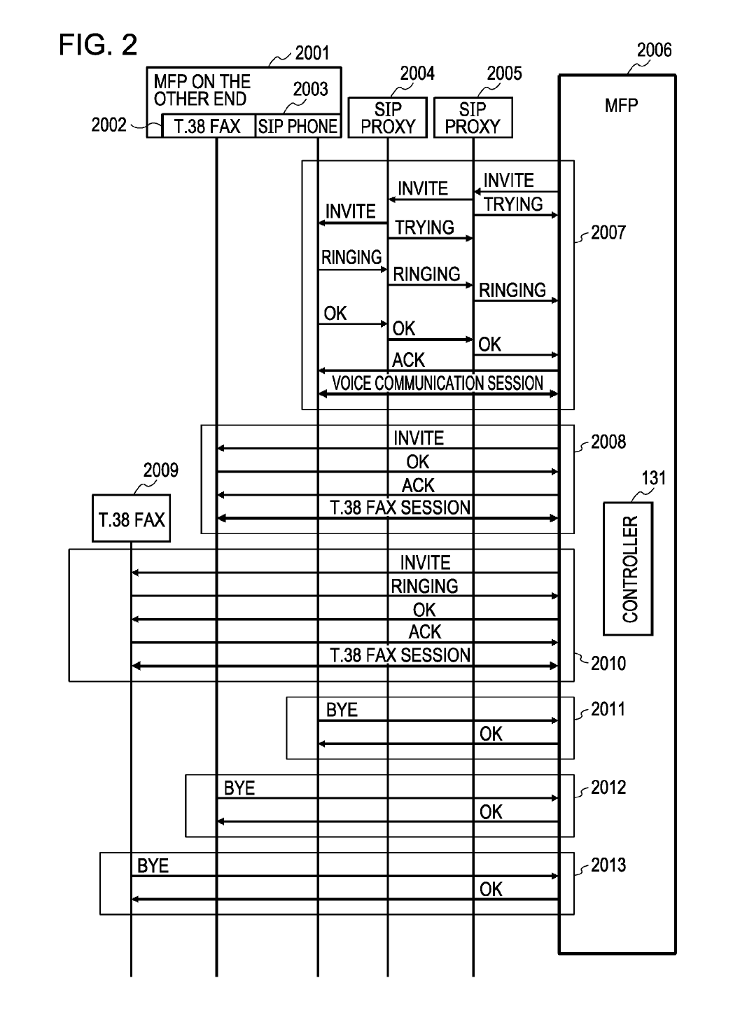

FIG. 2 is a block diagram illustrating a configuration of a data communication control unit in an image forming apparatus to which the data communication apparatus according to the present embodiment is applied. Hereinafter, an example of multiplex data communication of IP telephony based on SIP and FAX communication based on T.38 in the data communication apparatus is described.

Referring to FIG. 2, an MFP 2001 includes a T.38 FAX function processing unit 2002 and an IP phone function processing unit 2003. In this example, SIP proxies 2004 and 2005 are provided, but SIP allows communication without any proxy.

An image forming apparatus 2006 is an MFP, for example. The image forming apparatus 2006 includes a network controller 131 and is capable of performing multiplex communication or voice communication with another image forming apparatus or a facsimile apparatus on the other end via a network. A protocol group 2007 illustrates a session example of SIP in a case where the image forming apparatuses 2006 and 2001 perform SIP voice communication.

In the protocol group 2007, “INVITE” is a signal to request a call. “TRYING” is a signal indicating that a process is being performed. “RINGING” is a signal to request a ringing tone. “OK” is a signal indicating that a receiver has been picked up. “ACK” is a signal indicating acknowledgement. A “voice communication session” is a session where coded voice data based on a PCM (Pulse Code Modulation) coding method of ITU-T G.711 is transmitted/received.

An SIP protocol group 2008 includes protocols for performing network FAX communication based on the T.38 protocol with the image forming apparatus 2001 at the same time as the protocol group 2007. Actually, protocol signals such as “INVITE” are transmitted via the SIP proxies.

In the SIP protocol group 2008, “INVITE” is a signal to request a call. “OK” is a signal indicating that a receiver has been picked up. “ACK” is a signal indicating acknowledgement. A “T.38 FAX session” is a facsimile session where coded data of MH (Modified Huffman) or MR (Modified Read) is transmitted based on ITU-T T.38.

A T.38 facsimile apparatus 2009 performs facsimile communication via a network based on the T.38 protocol.

An SIP protocol group 2010 includes protocols to perform FAX communication with the T.38 facsimile apparatus 2009 based on T.38.

In the SIP protocol group 2010, “INVITE” is a signal to request a call. “RINGING” is a signal to request a ringing tone. “OK” is a signal indicating that a receiver has been picked up. “ACK” is a signal indicating acknowledgement. A “T.38 FAX session” is a facsimile session where coded data of MH or MR is transmitted based on ITU-T T.38.

A protocol group 2011 includes protocols to end the session of the protocol group 2007. In the protocol group 2011, “BYE” is a signal indicating an intention of ending the voice communication. “OK” is a signal indicating agreement.

A protocol group 2012 includes protocols to end the session of the protocol group 2008 with a printer. In the protocol group 2012, “BYE” is a signal indicating an intention of ending the communication. “OK” is a signal indicating agreement.

A protocol group 2013 includes protocols to end the session of the SIP protocol group 2010. In the protocol group 2013, “BYE” is a signal indicating an intention of ending the communication. “OK” is a signal indicating agreement.

As described above, in the MFP according to the present embodiment, a plurality of facsimile communications based on the T.38 protocol can be performed in parallel with voice communication based on SIP.

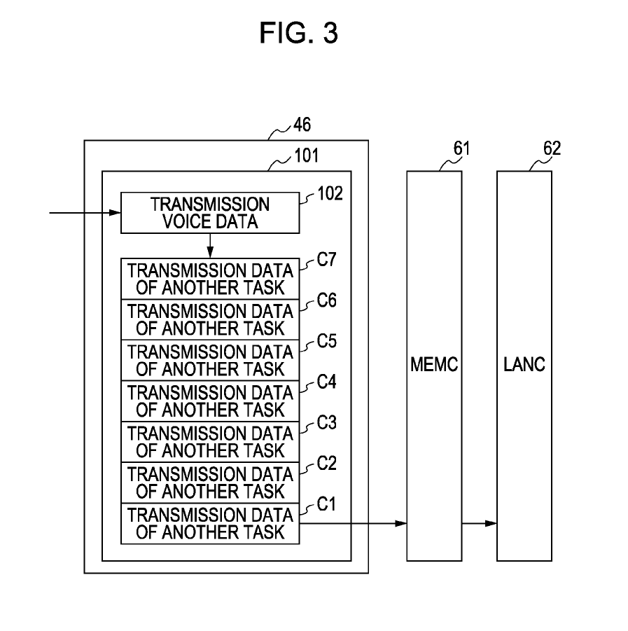

FIG. 3 is a block diagram illustrating a state of a transmission buffer of the data communication apparatus illustrated in FIG. 1. In this state, pieces of transmission task data other than transmission voice data are accumulated in the transmission buffer provided in the SDRAM 46 illustrated in FIG. 1, and a delay occurs before the transmission voice data is transmitted. In FIG. 3, the parts that are the same as those in FIG. 1 are denoted by the same reference numerals.

Referring to FIG. 3, the transmission buffer 101 includes a plurality of queues C1 to C7, and pieces of transmission data of another task are fully held therein. The transmission voice data 102 is data related to voice communication.

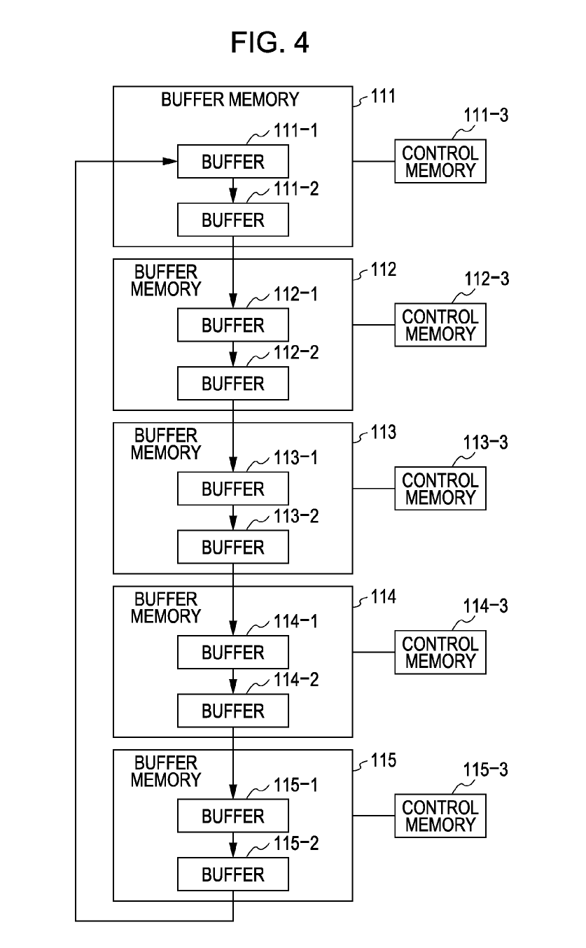

FIG. 4 is a block diagram illustrating a configuration of the transmission buffer and reception buffer of the data communication apparatus illustrated in FIG. 1.

As illustrated in FIG. 4, buffer memories 111 to 115 are provided. The buffer memory 111 includes internal buffers 111-1 and 111-2. A control memory 111-3 stores information to control the buffer memory 111, for example, information indicating a burst length of burst transfer of DMA (Direct Memory Access) and whether the memory is empty or whether data has been read from the memory.

Likewise, the buffer memory 112 includes internal buffers 112-1 and 112-2. A control memory 112-3 stores information to control the buffer memory 112, for example, information indicating a burst length of burst transfer of DMA and whether the memory is empty or whether data has been read from the memory.

Likewise, the buffer memory 113 includes internal buffers 113-1 and 113-2. A control memory 113-3 stores information to control the buffer memory 113, for example, information indicating a burst length of burst transfer of DMA and whether the memory is empty or whether data has been read from the memory.

Likewise, the buffer memory 114 includes internal buffers 114-1 and 114-2. A control memory 114-3 stores information to control the buffer memory 114, for example, information indicating a burst length of burst transfer of DMA and whether the memory is empty or whether data has been read from the memory.

Likewise, the buffer memory 115 includes internal buffers 115-1 and 115-2. A control memory 115-3 stores information to control the buffer memory 115, for example, information indicating a burst length of burst transfer of DMA and whether the memory is empty or whether data has been read from the memory.

In the present embodiment, each of the buffer memories includes a plurality of buffers. With this configuration, one of the buffers can actually receive data while the other buffer can prepare for receiving data. Physically, these buffer memories may be configured by dividing a memory or may be individually provided. In the present embodiment, the respective buffer memories are connected in a chain shape to form a ring buffer.

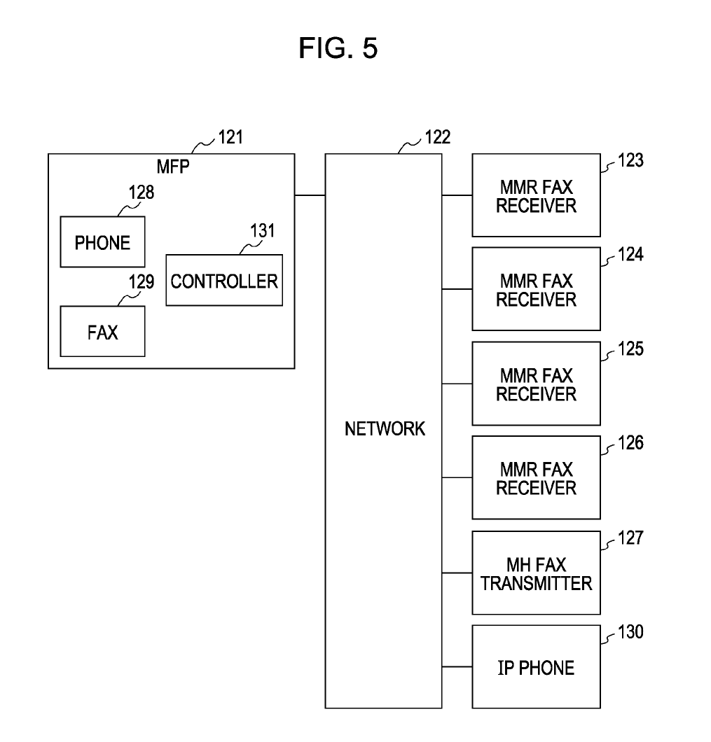

FIG. 5 is a block diagram illustrating an example of a network system to which the data communication apparatus according to the present embodiment is applied. In the system according to this example, an MFP including the data communication apparatus connects to many IP facsimile apparatuses or an IP phone via a network. In this system, voice communication with an IP phone and communication with a plurality of IP facsimile apparatuses can be performed at the same time.

Referring to FIG. 5, an MFP 121 includes a scanner unit, a printer unit, and a communication control unit (not shown). The communication control unit is a device to execute the function of the data communication apparatus according to the present embodiment.

A network 122 connects to FAX receivers 123 to 126, a FAX transmitter 127, and an IP phone 130. The FAX receivers 123 to 126 use MMR as a coding method, whereas the FAX transmitter 127 uses MH as a coding method.

A phone 128 is capable of performing voice communication by SIP and is included in the MFP 121. A FAX 129 is capable of communicating with a plurality of the FAX receivers 123 to 126 and the FAX transmitter 127 in parallel. The IP phone 130 is capable of performing voice communication with the phone 128 by SIP. The controller 131 performs overall control of the scanner function, the print function, the facsimile function, and the voice communication over IP (“voice communication” hereinafter) function of the MFP 121. The controller 131 includes a CPU, a ROM (Read Only Memory), and an SDRAM (not shown). The SDRAM corresponds to the SDRAM 46 illustrated in FIG. 1 and functions as a reception buffer and a transmission buffer.

FIG. 6 is a flowchart illustrating an example of a first data communication process performed in the data communication apparatus according to the present embodiment. This flowchart illustrates a process from when a user requests transmission of a call until voice communication starts. Each of the steps in FIG. 6 is realized when the controller 131 of the MFP 121 loads a control program from the ROM, etc. to the SDRAM and executes the program.

First, a user requests voice communication, more specifically, the user presses a dial call button, etc. on a handset. Then, the controller 131 determines in step S51 whether an IP FAX transmitting task is now being performed. The controller 131 can make a determination based on the state of the LANC 62 illustrated in FIG. 3.

If the controller 131 determines that no IP FAX transmitting task is now being performed, the process proceeds to step S52, where the controller 131 determines whether a predetermined amount or more of data exists in the queues C1 to C7 functioning as LAN transmission data queues illustrated in FIG. 3. If the controller 131 determines that the predetermined amount or more of data exists, the controller 131 keeps transmission of a call waiting in step S58, and the process returns to step S52.

On the other hand, if it is determined in step S52 that the predetermined amount or more of data does not exist in the queues, the process proceeds to step S53, where start of transmitting a call from the phone 128 is permitted.

Then, in step S54, the controller 131 determines whether reception of a call can be started based on a usage state of the reception buffer to receive voice data from the apparatus on the other end. If the controller 131 determines that reception of a call cannot be started, the process proceeds to step S59, where the controller 131 keeps transmission of a call waiting. In step S60, the controller 131 displays a message indicating that state, for example, “The network is busy, please wait.” on a display of an operation unit of the MFP 121, and the process returns to step S54.

On the other hand, if the controller 131 determines in step S54 that reception of a call can be started, the process proceeds to step S55, where the controller 131 permits start of voice communication. Then, in step S56, the controller 131 erases the message “The network is busy, please wait.” Then, a process of starting voice communication is performed.

On the other hand, if the controller 131 determines in step S51 that an IP FAX transmitting task is now being performed, the process proceeds to step S57, where the controller 131 displays a message “The network is busy, please wait.” and also outputs the message verbally.

In step S61, the controller 131 determines whether a load of decoding transmission data is heavier than a load of coding the transmission data. If the determination in step S61 is “YES”, the process proceeds to step S62, where the controller 131 keeps the transmitting task waiting. Then, in step S63, the controller 131 determines whether another multiplex transmitting task is being performed. If it is determined that any multiplex transmitting task is not being performed, the process returns to step S52. If it is determined that another multiplex transmitting task is being performed, the process returns to step S61.

On the other hand, if the determination in step S61 is “NO”, the process proceeds to step S64, where the controller 131 determines whether the load of decoding the transmission data is equal to the load of coding the transmission data. If the determination in step S64 is “YES”, the process returns to step S62. If the determination is “NO”, the process returns to step S63.

The data communication apparatus illustrated in FIG. 1 is affected if transmission data of another task is accumulated in the queues C1 to C7 of the transmission buffer 101 as illustrated in FIG. 3 when a user wants to start a voice communication. Even if voice data is transmitted to the transmission buffer, delay occurs here until start of the voice communication.

For example, the transmission buffer 101 has the configuration illustrated in FIG. 4, and thus the data to be transmitted to the LANC 62 is processed in the order of the buffer memory 112, the buffer memory 113, the buffer memory 114, and the buffer memory 115. At this time, if the voice data is input to the buffer memory 111, which is now empty, a process is not performed on the data.

That is, the data communication apparatus is capable of communicating with many facsimile apparatuses, as illustrated in FIG. 5, and such a state is more likely to occur as the number of multiplex communications is larger.

Thus, a voice communication request from a user is restricted based on the control procedure illustrated in FIG. 6. Specifically, when other transmission data remains in the queues, start of voice communication is permitted when the amount of residual data becomes sufficiently small.

Accordingly, when data of facsimile data communication, etc. is accumulated in the transmission buffer at the time of a request for transmission of a call, start of voice communication at the same time with the facsimile data communication is restricted. In this way, delay of the voice communication and skip of voice can be prevented.

The data communication apparatus having the above-described configuration and performing voice communication and facsimile communication with apparatuses on the other ends via the Internet includes the following characteristic function. First, a reception buffer or a transmission buffer to store voice data based on voice communication with an apparatus on the other end via the Internet or facsimile data based on facsimile communication with an apparatus on the other end is provided in the SDRAM 46. The data communication apparatus includes a deciding function of deciding whether voice data should be preferentially processed by determining a processing state of the voice data or the facsimile data stored in the reception buffer or the transmission buffer. This deciding function may be executed by the LANC 62 or the controller of the MFP.

If a decision is made to preferentially process the voice data of voice communication stored in the reception buffer, facsimile communication is maintained. In parallel to this, control of preferentially receiving or transmitting the voice data stored in the reception buffer or the transmission buffer is performed in the manner described in the following embodiment. Here, the processing state varies depending on facsimile data communication information using the reception buffer at the time of voice data communication request using the reception buffer. Also, as illustrated in FIG. 6, when a predetermined amount of facsimile communication data is stored in the reception buffer or the transmission buffer at the time of a voice communication request, the request is restricted and the state is presented to the user. Accordingly, the user can restrict communication involving deterioration of voice during voice communication.

A hardware configuration of a data communication apparatus according to the second exemplary embodiment includes the same resources as those in the data communication apparatus illustrated in FIG. 1, and the corresponding description is omitted. Also, the data communication apparatus according to the present embodiment uses SIP as a protocol of communication via a network and ITU-T T.38 as a protocol of facsimile transmission.

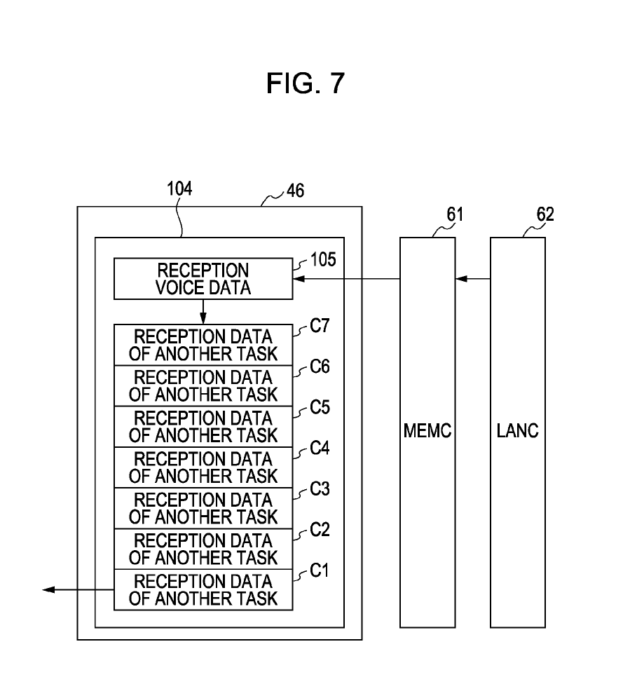

FIG. 7 is a block diagram illustrating a state of a reception buffer of the data communication apparatus according to the present embodiment. In FIG. 7, the parts that are the same as those in FIG. 3 are denoted by the same reference numerals. In this state, reception task data other than reception voice data is accumulated in the reception buffer provided in the SDRAM 46 illustrated in FIG. 1, so that delay occurs until the reception voice data is transmitted. The parts that are the same as those in FIG. 1 are denoted by the same reference numerals.

In FIG. 7, the reception buffer 104 includes a plurality of queues C1 to C7, and pieces of reception data of another task are fully held therein. Also, reception voice data 105 related to voice communication is held.

As illustrated in FIG. 7, if reception data of another task is accumulated in the queues C1 to C7 in the data communication apparatus when a user wants to start voice communication, an effect of the accumulated data causes delay when voice data is received by the reception buffer.

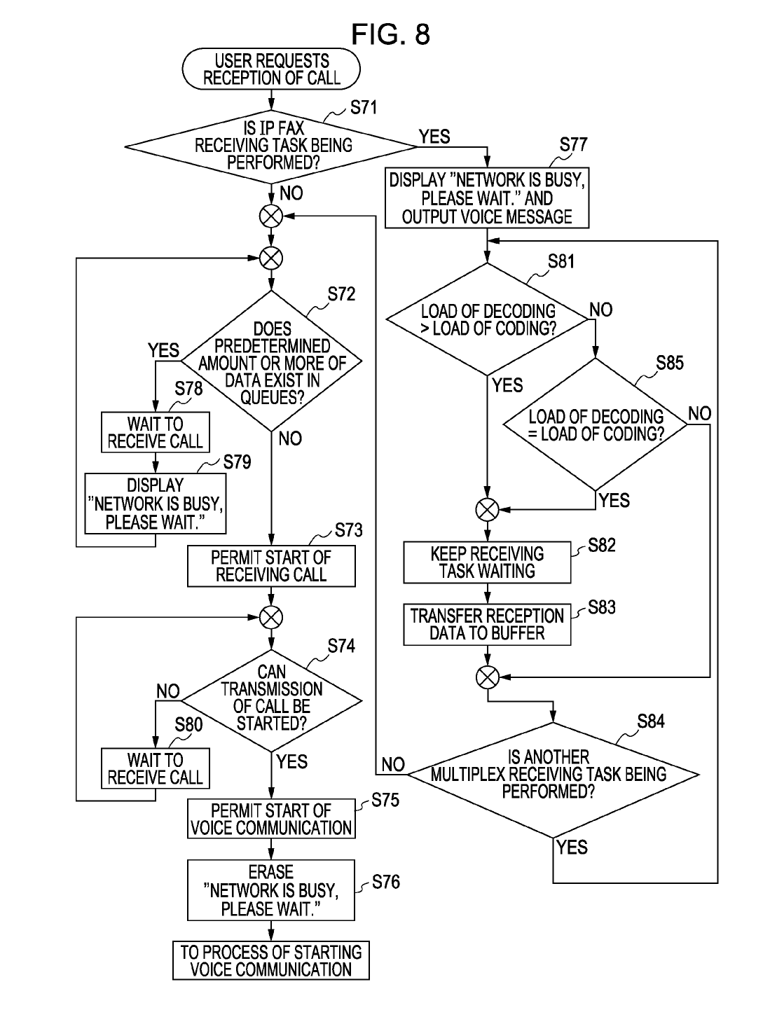

For example, the reception buffer has the configuration illustrated in FIG. 4, and data to be transmitted to the HOST side is processed in the order of the buffer memory 112, the buffer memory 113, the buffer memory 114, and the buffer memory 115. At this time, if the voice data is input to the buffer memory 111, which is now empty, a process is not performed on the data. Such a state is more likely to occur particularly when communication with many facsimile apparatuses can be performed as illustrated in FIG. 5 and as the number of multiplex communications is larger. For this reason, reception of voice data is restricted in the manner as illustrated in FIG. 8.

FIG. 8 is a flowchart illustrating an example of a second data communication process performed in the data communication apparatus according to the present embodiment. This flowchart illustrates a process from when a user requests reception of a call until voice communication starts. Each of the steps illustrated in FIG. 8 is realized when the controller 131 of the MFP 121 loads a control program from the ROM, etc. to the SDRAM and executes the program.

First, a user requests reception of a voice communication, more specifically, the user presses a dial call button, etc. on a handset. Then, the controller 131 determines in step S71 whether an IP FAX receiving task is being performed. The controller 131 can make a determination based on the state of the LANC 62 illustrated in FIG. 3.

If the controller 131 determines that no IP FAX receiving task is being performed, the process proceeds to step S72, where the controller 131 determines whether a predetermined amount or more of data exists in the queues C1 to C7 functioning as LAN reception data queues illustrated in FIG. 7. If the controller 131 determines that the predetermined amount or more of data exists, the controller 131 keeps reception of a call waiting in step S78, and displays a message “The network is busy, please wait.” on a display of a control unit of the MFP 121 in step S79. Then, the process returns to step S72.

On the other hand, if it is determined in step S72 that the predetermined amount or more of data does not exist in the queues, the process proceeds to step S73, where start of receiving a call from the phone 128 is permitted.

Then, in step S74, the controller 131 determines whether transmission of a call can be started based on a usage state of the transmission buffer to transmit voice data to the apparatus on the other end. If the controller 131 determines that transmission of a call cannot be started, the process proceeds to step S80, where the controller 131 keeps reception of a call waiting. Then, the process returns to step S74.

On the other hand, if the controller 131 determines in step S74 that transmission of a call can be started, the process proceeds to step S75, where the controller 131 permits start of voice communication. Then, in step S76, the controller 131 erases the message “The network is busy, please wait.” Then, a process of starting voice communication is performed.

On the other hand, if the controller 131 determines in step S71 that an IP FAX receiving task is being performed, the process proceeds to step S77, where the controller 131 displays a message “The network is busy, please wait.” and also outputs a voice message.

In step S81, the controller 131 determines whether a load of decoding reception data is heavier than a load of coding the reception data. If the determination in step S81 is “YES”, the process proceeds to step S82, where the call receiving task is kept waiting. In step S83, received data is transferred to the buffer and is temporarily stored therein. Then, in step S84, the controller 131 determines whether another multiplex receiving task is being performed. If it is determined that any multiplex receiving task is not being performed, the process returns to step S72. If it is determined that another multiplex receiving task is being performed, the process returns to step S81.

On the other hand, if the determination in step S81 is “NO”, the process proceeds to step S85, where the controller 131 determines whether the load of decoding reception data is equal to the load of coding the reception data. If the determination in step S85 is “YES”, the process returns to step S82. If the determination is “NO”, the process returns to step S84.

In the present embodiment, when a user requests voice communication and when reception data of another task remains in the queues C1 to C7 as illustrated in FIG. 7, the voice communication can be performed after the amount of data in the queues becomes sufficiently small.

That is, in the data communication apparatus having the above-described configuration, the following state occurs, that is, a state where reception data for facsimile communication is accumulated as a queue in a memory to accumulate the data received from the network. In such a case, if the coded voice data from the apparatus on the other end cannot be reproduced at regular intervals, control is performed so that an operation of receiving the voice data from the network is not started.

Accordingly, when data of facsimile data communication, etc. is accumulated in the reception buffer at the time of a request for reception of a call, start of voice communication at the same time with the facsimile data communication is restricted. In this way, delay of the voice communication and skip of voice can be prevented.

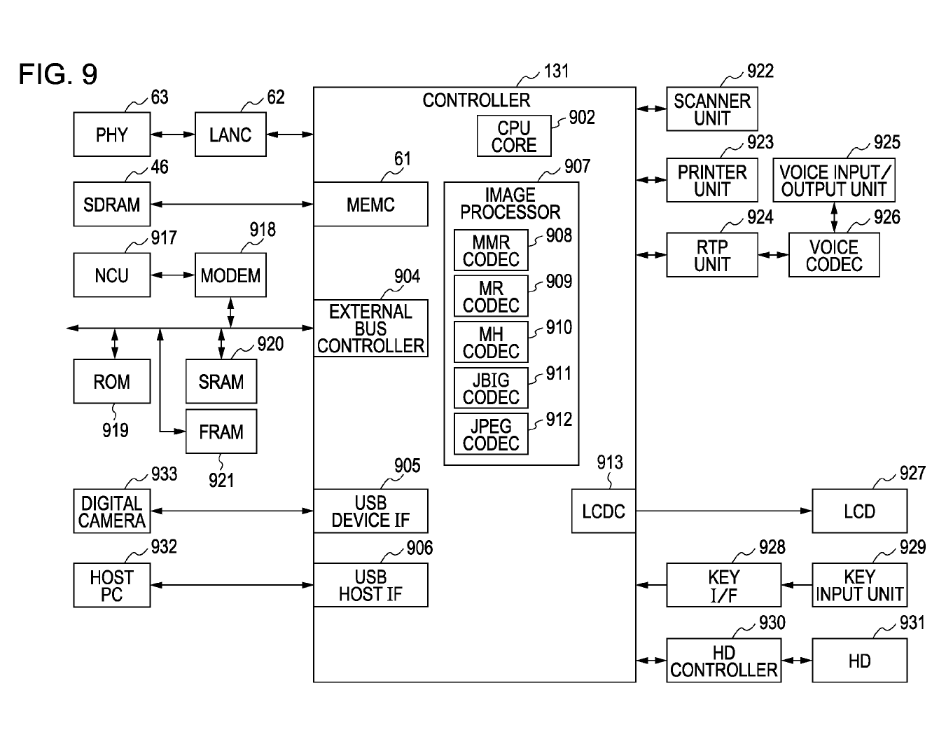

FIG. 9 is a block diagram illustrating an example of an image forming apparatus to which a data communication apparatus according to a third exemplary embodiment of the present invention can be applied. In the present embodiment, the image forming apparatus is an MFP having a print function, a scanner function, and a data communication function. The parts that are the same as those in FIGS. 1 and 5 are denoted by the same reference numerals.

In FIG. 9, a CPU core 902 controls respective devices. The memory controller 61 controls a memory. An external bus controller 904 controls access to a ROM 919, an SRAM (static RAM) 920, an FRAM (ferric RAM) 921, and a modem 918 connected to an external bus.

A USB (Universal Serial Bus) device interface 905 connects to a digital camera 933. A USB host interface 906 connects to a host PC (Personal Computer) 932. An image processor 907 includes codecs 908 to 912 to perform image processing. An LCDC (Liquid Crystal Display Controller) 913 controls display of an LCD 927, which is a display device. A key interface 928 processes input from a key input unit 929 provided in an operation unit, etc.

A hard disk controller 930 controls access to a hard disk (HD) 931. A scanner unit 922 controls an optical scanning unit (not shown) and outputs image information formed on an image forming device, such as a CCD (Charge-Coupled Device), to the controller 131. A printer unit 923 includes a printer engine (not shown).

An RTP (Real-time Transport Protocol) unit 924 includes a data unit and a controller and is capable of distributing interactive voice and video data in real time. Also, the RTP unit 924 includes a function of determining whether packets arrive in order and determining jitter until arrival of the packets by using time stamp information. A voice input/output unit 925 includes a headset, etc. A voice codec 926 performs predetermined signal processing on voice data to code/decode the voice data.

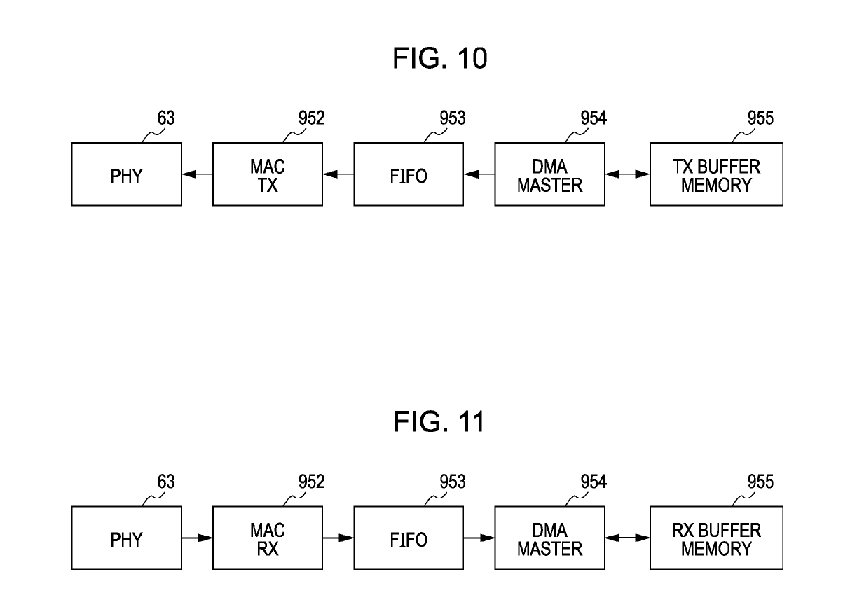

FIG. 10 illustrates a flow of data from the transmission buffer memory provided in the SDRAM 46 to the PHY 63 illustrated in FIG. 9.

In FIG. 10, the PHY (Physical Layer) unit 63 includes a physical layer IC. A medium access control block (MACTX) 952 is included in the LANC 62. Reference numeral 953 denotes a FIFO (first in, first out) memory. A DMA master 954 performs arbitration of direct memory access. A buffer memory 955 holds transmission data.

In this way, transmission data is transmitted from the buffer memory 955 to the FIFO memory 953 that is physically the same or different via the DMA master 954, is transferred to the MAC 952, and is then transmitted to a network via the PHY 63.

FIG. 11 illustrates a flow of data from the PHY unit 63 illustrated in FIG. 10 to the reception buffer memory 955. The parts that are functionally the same as those in FIG. 10 are denoted by the same reference numerals.

As illustrated in FIG. 11, reception data from a network is transmitted to the FIFO memory 953 via the PHY 63 and the MAC 952, and is then transferred to the buffer memory 955 on the receiver side via the DMA master 954.

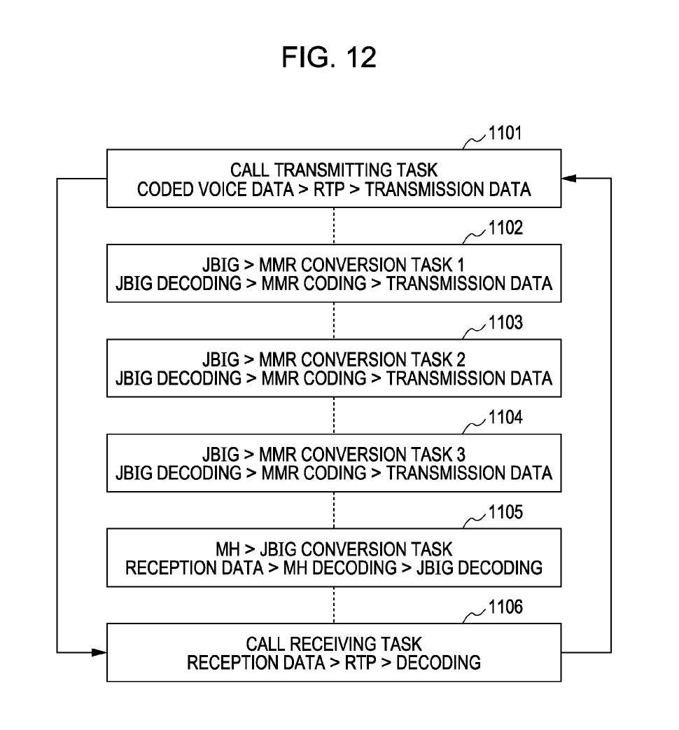

FIG. 12 is a block diagram illustrating a multi task process performed by the data communication apparatus illustrated in FIG. 9. The tasks illustrated in FIG. 12 includes a call transmitting task 1101, transmission data generating tasks 1102 to 1104 including code conversion, a reception data accumulating task 1105 including code conversion, and a call receiving task 1106.

In the present embodiment, the controller 131 performs control of keeping any of the transmission data generating tasks 1102 to 1104 and the reception data accumulating task 1105 waiting and stopping transfer to the buffer memory 955 for transmission.

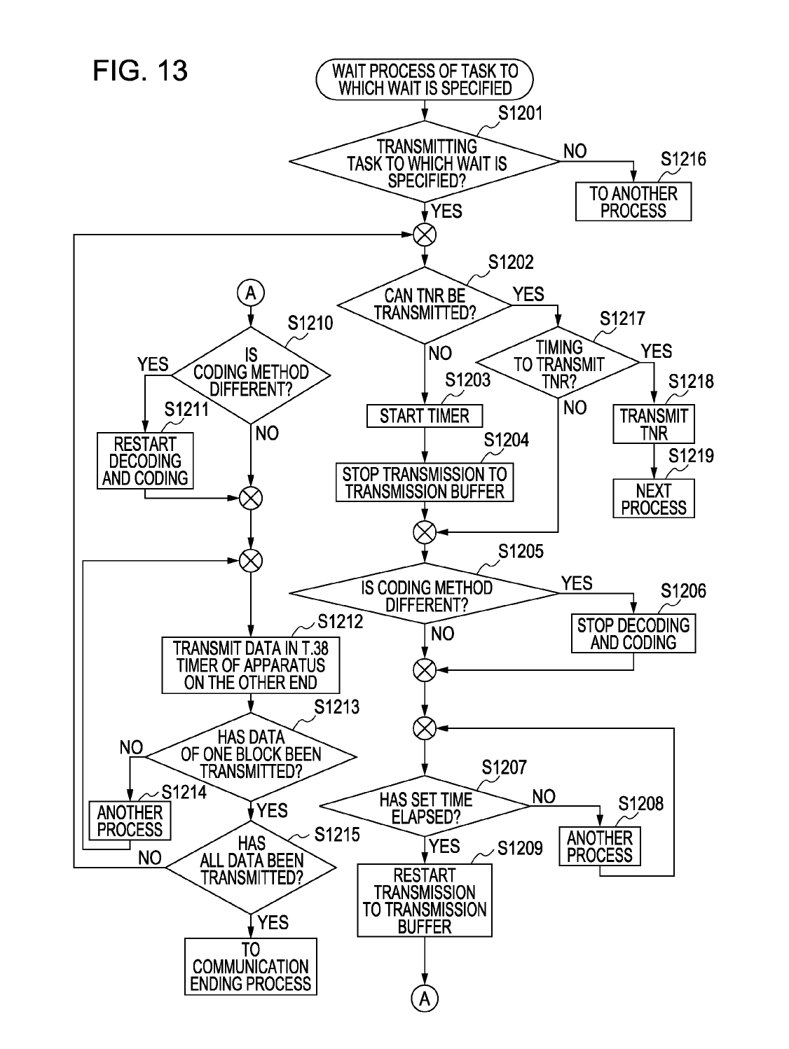

FIG. 13 is a flowchart illustrating an example of a third data communication process performed in the data communication apparatus according to the present embodiment. In the present embodiment, an operation of transferring transmission data for the facsimile communication to the buffer memory is kept waiting in accordance with the T.38 protocol during transmission of coded voice data. Each of the steps illustrated in FIG. 12 is realized when the controller 131 of the MFP 121 loads a control program from the ROM, etc. to the SDRAM and executes the program.

First, in step S1201, the controller 131 determines whether the task is a transmitting task to which wait is specified. That is, the controller 131 determines whether the task is a task of transferring transmission data for facsimile communication. If the controller 131 determines that the task is not a transmitting task to which wait is specified, the process proceeds to step S1216, and another process is performed.

On the other hand, if the controller 131 determines in step S1201 that the task is a transmitting task to which wait is specified, the process proceeds to step S1202, where the controller 131 determines whether a TNR (Transmitter Not Ready) signal can be transmitted to an apparatus on the other end. If the controller 131 determines that the TNR signal can be transmitted, the process proceeds to step S1217, where the controller 131 determines whether timing to transmit the TNR signal has come. If the controller 131 determines that the timing to transmit the TNR signal has come, the process proceeds to step S1218, where the TNR signal is transmitted to the apparatus on the other end. Then, a next process is performed in step S1219.

On the other hand, if the controller 131 determines in step S1217 that the timing to transmit the TNR signal has not come, the process proceeds to step S1205. If the controller 131 determines in step S1202 that the TNR signal cannot be transmitted to the apparatus on the other end, the process proceeds to step S1203, where a timer is started. Then, in step S1204, transmission to the buffer memory 955 for transmission is stopped.

In step S1205, the controller 131 determines whether a method for coding accumulated data is different from that in the apparatus on the other end. If the coding method is different, decoding and coding are stopped in step S1206 and the process proceeds to step S1207.

On the other hand, if the controller 131 determines in step S1205 that the coding method is the same, the process proceeds to step S1207, where the controller 131 determines whether the time set in the timer in step S1203 has elapsed. If the controller 131 determines that the time has not elapsed, another process is performed in step S1208 and the process returns to step S1207.

On the other hand, if the controller 131 determines in step S1207 that the time set in the timer has elapsed, the process proceeds to step S1209, where transmission to the buffer memory 955 restarts. Accordingly, transmission of facsimile data accumulated in the buffer memory 955 is delayed, but a transmission line is not disconnected, so that voice data processing can be performed.

In step S1210, the controller 131 determines again whether the method for coding data accumulated in the buffer memory 955 is different from that in the apparatus on the other end. If the coding method is different, decoding and coding are restarted in step S1211 and the process proceeds to step S1212.

On the other hand, if the controller 131 determines in step S1210 that the coding method is the same, the process proceeds to step S1212, where data transmission is performed in a timer of the T.38 protocol of the apparatus on the other end.

Then, in step S1213, the controller 131 determines whether transmission data of one block has been transmitted. If transmission data of one block has not been transmitted, another process is performed in step S1214, and the process returns to step S1212.

On the other hand, if the controller 131 determines in step S1213 that transmission data of one block has been transmitted, the process proceeds to step S1215, where the controller 131 determines whether all transmission data to be stored in the buffer memory 955 has been transmitted. If all transmission data has been transmitted, the process moves to a communication ending phase.

On the other hand, if the controller 131 determines in step S1215 that not all transmission data has been transmitted, the process returns to step S1202.

In the present embodiment, voice communication can be performed in a state of communicating with an apparatus on the other end while suspending transfer to the buffer memory 955 for transmission and restarting the transfer to transmit a minimum amount of transmission data so that disconnection does not occur based on the timer of the apparatus on the other end. The minimum amount of transmission data is data of one block, and thus the effect on the voice communication can be minimized.

As described above, according to the present embodiment, an operation of transferring transmission data for facsimile communication to the buffer memory 955 for transmitting the data to the network can be kept waiting while the data communication apparatus is transmitting coded voice data.

In the above-described embodiment, voice communication is performed in a state of communicating with an apparatus on the other end while suspending transfer to the buffer memory 955 for transmission and restarting transfer to transmit a minimum amount of transmission data so that disconnection does not occur based on the timer of the apparatus on the other end.

On the other hand, in the data communication apparatus according to the first embodiment, data communication in which a coding method for data accumulated in a memory is different between the own apparatus and the apparatus on the other end needs to be performed.

When the data communication state changes to such a state, the ability of the CPU and the bus occupancy rate of the controller 131 controlling the data communication cannot deal with the load of the data communication. For this reason, as illustrated in FIG. 13, control is performed to stop and restart a code converting process including coding and decoding during voice data communication.

More specifically, when multiplex communication is performed during data communication with an apparatus as illustrated in FIG. 5, the method for coding data accumulated in the memory is different between the own apparatus and the apparatus on the other end in many cases. In those cases, code conversion has a great effect on the system. Also, such a data converting process increases a load imposed on the system including the ability of the CPU and the occupancy rate of the bus.

In order to prevent failure of the data communication system, the code converting process increasing the load is stopped, as illustrated in FIG. 13. Accordingly, an effect on voice data communication can be reduced even if a load of data processing in data communication varies.

In the data communication apparatus according to the first embodiment, the coders 54 and 55 and the decoders 53 and 56 illustrated in FIG. 1 serve as a code converting unit, and these coders and decoders use the same coding method. The coders 54 and 55 and the decoders 53 and 56 may be configured by hardware or software.

A coding/decoding process performed by those coders/decoders may increase a load imposed on the system including the ability of the CPU and the occupancy rate of the bus of the controller 131.

For example, the buffer memories 65 and 66 illustrated in FIG. 1 are physically the same as a memory used in another application, such as the SDRAM 46, in many cases. In those cases, since memory resources are limited, multiplex use thereof can cause failure of the system.

In order to prevent the failure, the controller 131 stops coding and decoding when voice data communication and facsimile data communication are performed in parallel, as illustrated in FIG. 13. Accordingly, an effect on voice data communication can be reduced even if data processing resources for data communication are limited.

In the above-described embodiment, a multitask process performed by the data communication apparatus illustrated in FIG. 9 has been described. More specifically, the controller 131 performs control of keeping any of the transmission data generating tasks 1102 to 1104 and the reception data accumulating task 1105 waiting so as to stop transfer to the buffer memory 955 for transmission.

However, when code conversion is not necessary, for example, when the memory accumulating method in both the apparatuses on this end and the other end is JBIG, wait control need not be performed.

In another embodiment of the present invention, the controller 131 determines whether the memory accumulating method is the same in the own apparatus and the apparatus on the other end in the multitask process illustrated in FIG. 12.

If the controller 131 determines that there is a communication task not requiring code conversion, for example, the memory accumulating method in both the own apparatus and the apparatus on the other end is JBIG, the controller 131 performs control not to stop the communication task. The controller 131 preferentially keeps a task in which the memory accumulating method is different between the own apparatus and the apparatus on the other end waiting.

With this control, an unnecessary wait control is not performed to image data communication in a case where code conversion need not be performed when at least two or more transmitting operations are performed in parallel with voice communication.

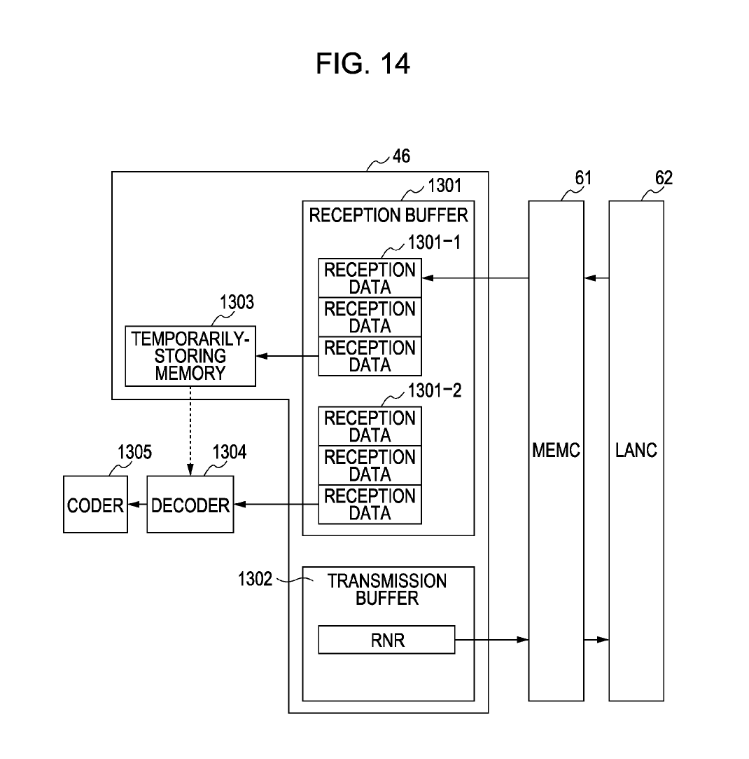

FIG. 14 is a block diagram illustrating a configuration of a main part of a data communication apparatus according to yet another embodiment of the present invention. The parts that are the same as those in FIGS. 1 and 9 are denoted by the same reference numerals. Hereinafter, an operation of storing reception data remaining in a reception buffer in a temporally-storing memory without transferring it to a decoder and transmitting an RNR (Receive Not Ready) signal of ITU-T T.30 is described.

In FIG. 14, a reception buffer 1301 is provided in the SDRAM 46. In the present embodiment, the reception buffer 1301 includes reception buffer units 1301-1 and 1301-2 and holds received image data therein. A transmission buffer 1302 is also provided in the SDRAM 46 and holds an RNR signal of ITU-T T.30.

A coder 1305 converts data to be accumulated in an image memory to JBIG data. A decoder 1304 decodes received data. A temporarily-storing memory 1303 temporarily stores received data so that transmission of the data to the decoder 1304 is suspended. The transmission buffer 1302 and the reception buffer 1301 may be physically integrated. In this embodiment, data is transmitted/received in the manner illustrated in FIGS. 10 and 11.

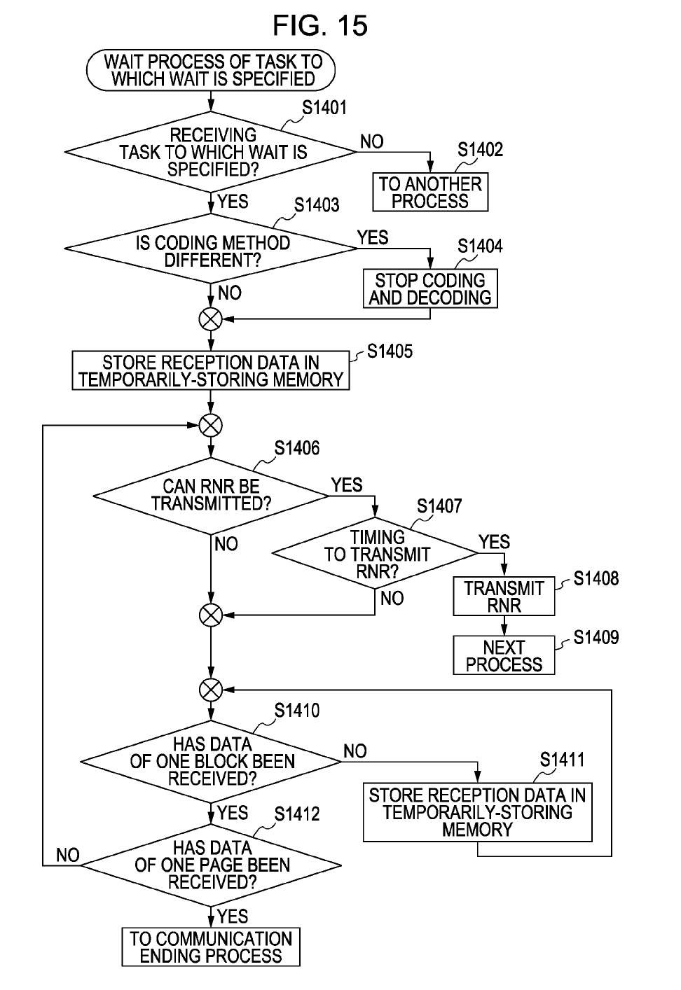

In the present embodiment, reception data is not directly transferred to the decoder 1304 and the coder 1305, but is stored in the temporarily-storing memory 1303, as illustrated in FIG. 14. Hereinafter, a data communication process according to the present embodiment is described with reference to the flowchart illustrated in FIG. 15.

FIG. 15 is a flowchart illustrating an example of a fourth data communication process performed in the data communication apparatus according to the present embodiment. In this example, a receiving task to which wait is specified is performed. Each of the steps illustrated in FIG. 15 is performed when the controller 131 of the MFP 121 loads a control program from the ROM, etc. to the SDRAM and executes the program.

First, in step S1401, the controller 131 determines whether wait is specified to the receiving task corresponding to the reception data held in the reception buffer 1301. If the controller 131 determines that wait is not specified to the receiving task, the process proceeds to step S1402, where another process is performed.

On the other hand, if the controller 1301 determines in step S1401 that wait is specified to the task, the process proceeds to step S1403, where the controller 131 determines whether the method for coding data accumulated in the reception buffer 1301 is different from that in the apparatus on the other end. If the controller 131 determines that the coding method is different, the process proceeds to step S1404, where coding and decoding are stopped, and the process proceeds to step S1405.

On the other hand, if the controller 131 determines in step S1403 that the coding method is the same, the reception data accumulated in the reception buffer 1301 is stored in the temporarily-storing memory 1303 in step S1405.

In step S1406, the controller 131 determines whether the RNR signal stored in the transmission buffer 1302 can be transmitted to the apparatus on the other end. If the controller 131 determines that the RNR signal can be transmitted, the controller 131 further determines in step S1407 whether the timing to transmit the RNR signal has come. If the controller 131 determines that the timing has come, the process proceeds to step S1408, where the controller 131 transmits the RNR signal stored in the transmission buffer 1302 to the apparatus on the other end. Then, a next process is performed in step S1409. On the other hand, if the controller 131 determines in step S1406 that the RNR signal cannot be transmitted to the apparatus on the other end, the process proceeds to step S1410. Likewise, if the controller 131 determines in step S1407 that the timing to transmit the RNR signal has not come, the process proceeds to step S1410.

In step S1410, the controller 131 determines whether data of one block has been received. The size of one block is predetermined.

If it is determined that data of one block has not been received, the process proceeds to step S1411, where the reception data stored in the reception buffer unit 1301-1 is stored in the temporarily-storing memory 1303, and the process returns to step S1410.

On the other hand, if it is determined in step S1410 that data of one block has been received, the process proceeds to step S1412, where the controller 131 determines whether data of one page has been received. If data of one page has been received, the process proceeds to a communication ending process. If data of one page has not been received, the process returns to step S1406.

Accordingly, reception data for facsimile communication is accumulated as a queue in the reception buffer 1301 for accumulating data received from a network. At this time, the accumulated reception data can be temporarily stored in the temporarily-storing memory 1303, and wait control can be performed on a decoding process in the decoder 1304 in the subsequent stage. That is, by using the temporarily-storing memory 1303 as a delay memory of data communication instead of using a so-called timer process, wait control can be performed. Also, by using the delay memory function, an effect on voice data communication can be reduced even if data processing resources for data communication are limited.

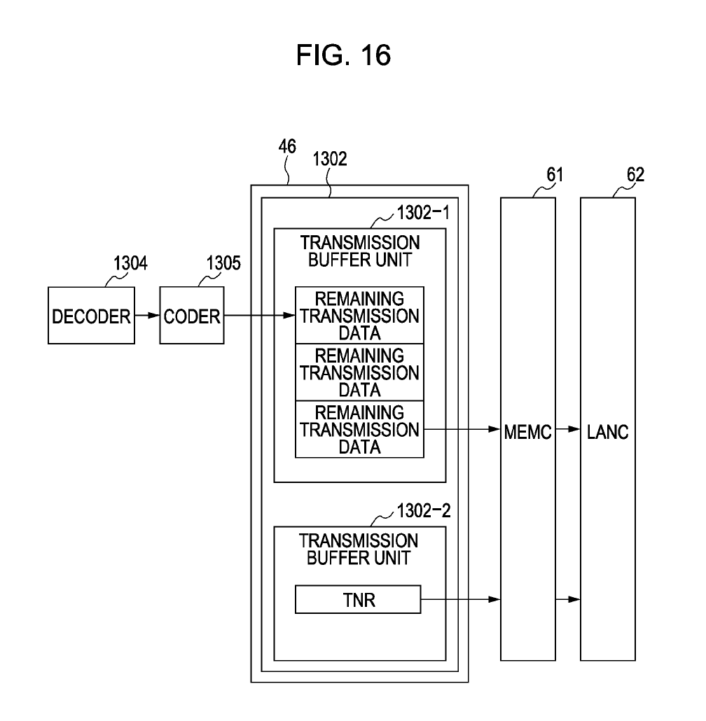

FIG. 16 is a block diagram illustrating a configuration of a main part of a data communication apparatus according to still yet another embodiment of the present invention. The parts that are the same as those in FIG. 14 are denoted by the same reference numerals. Hereinafter, a process of transmitting a TNR signal of ITU-T T.30 after transmitting remaining transmission data to a network is described. Here, TNR stands for “Transmitter Not Ready”.

In FIG. 16, transmission data remains in queues in a transmission buffer unit 1302-1. A transmission buffer unit 1302-2 holds a TNR signal of ITU-T T.30. Alternatively, the transmission buffer units 1302-1 and 1302-2 can be integrated into a single transmission buffer.

In the data communication apparatus according to the present embodiment, a process of transmitting a TNR signal is performed in the manner illustrated in FIG. 16. For example, the TNR signal is transmitted at precise timing (described below) when a user starts voice communication.

The facsimile data is accumulated as a queue in the transmission buffer 1302-1 for transmitting transmission data to a network. At this time, the TNR signal defined by ITU-T T.30 is transmitted to the receiver on the other end in order to reduce the queue accumulated in the transmission buffer unit 1302-1. Accordingly, a process of transferring the facsimile transmission data stored in the transmission buffer unit 1302-1 in the data communication apparatus can be kept waiting without using a timer process.

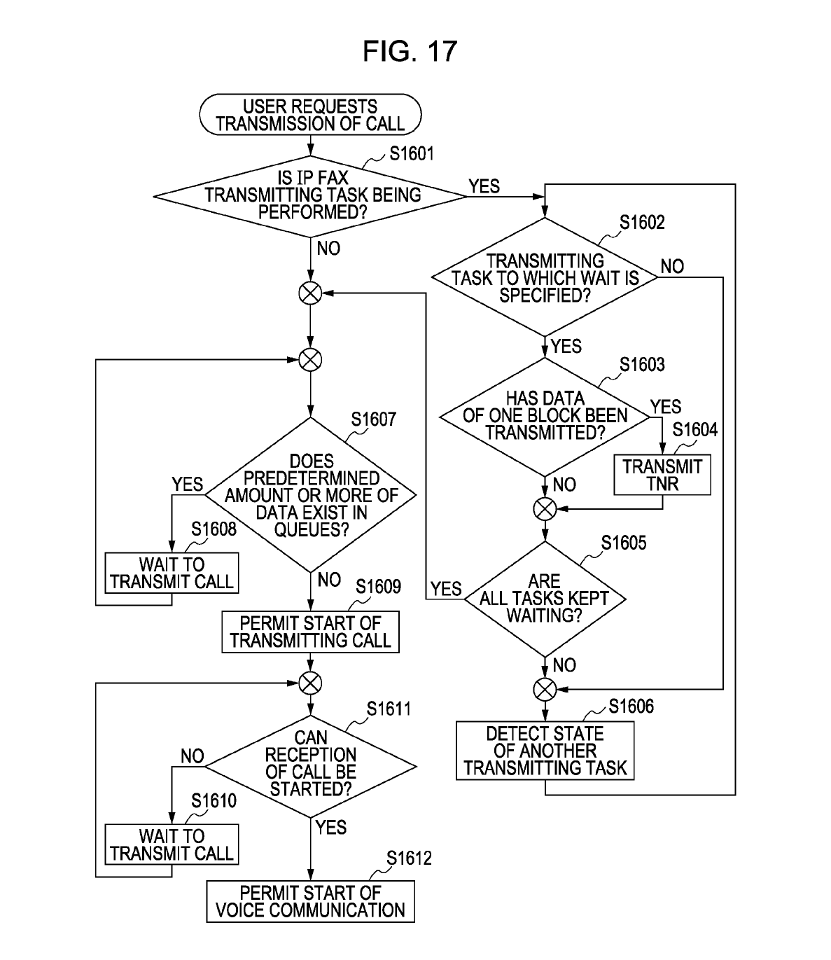

FIG. 17 is a flowchart illustrating an example of a fifth data communication process performed in the data communication apparatus according to the present embodiment. In this example, a transmitting task to which wait is specified is performed. Each of the steps illustrated in FIG. 17 is realized when the controller 131 of the MFP 121 loads a control program from the ROM, etc. to the SDRAM and executes the program.

First, in step S1601, the controller 131 determines whether an IP FAX transmitting task is being performed. If the controller 131 determines that an IP FAX transmitting task is being performed, the process proceeds to step S1602, where the controller 131 determines whether the task is a transmitting task for voice communication to which wait is specified. If the controller 131 determines that the task is not a transmitting task to which wait is specified, the process proceeds to step S1606, where the controller 131 detects the state of another transmitting task to which wait is specified but which is not kept waiting in the transmission buffer 1302, and the process returns to step S1602.

On the other hand, if the controller 131 determines in step S1602 that the task is a transmitting task to which wait is specified, the process proceeds to step S1603, where the controller 131 determines whether data of one block has been transmitted. If the controller 131 determines that data of one block has been transmitted, the controller 131 transmits the TNR signal stored in the transmission buffer unit 1302-2 to the network in step S1604 and the process proceeds to step S1605.

On the other hand, if the controller 131 determines in step S1603 that data of one block has not been transmitted, the process proceeds to step S1605, where the controller 131 determines whether all transmitting tasks to which wait is specified are kept waiting. If the controller 131 determines that not all the tasks are kept waiting, the process proceeds to step S1606, where the controller 131 detects the state of another transmitting task to which wait is specified but which is not kept waiting, and the process returns to step S1602.

On the other hand, if the controller 131 determines in step S1601 that an IP FAX transmitting task is not being performed, the process proceeds to step S1607, where the controller 131 determines whether a predetermined amount or more of data to be transmitted via the network is stored in the transmission buffer unit 1302-1. If the controller 131 determines that the predetermined amount or more of data is stored, the controller 131 keeps transmission of voice data waiting in step S1608, and the process returns to step S1607.

On the other hand, if the controller 131 determines in step S1607 that the predetermined amount of transmission data is not stored, the process proceeds to step S1609, where the controller 131 permits start of transmitting the data stored in the transmission buffer unit 1302-1. Then, in step S1611, the controller 131 determines whether reception of a call can be started in order to receive data from the apparatus on the other end via the network. If the controller 131 determines that reception cannot be started, the controller 131 keeps transmission of a call waiting in step S1610. Then, the process returns to step S1611.

On the other hand, if the controller 131 determines in step S1611 that reception of a call can be started, the process proceeds to step S1612, where start of voice communication is permitted.

Accordingly, a process of transferring facsimile transmission data stored in the transmission buffer unit 1302-1 in the data communication apparatus can be kept waiting without using a timer process.

According to a previously described embodiment, the temporarily-storing memory 1303 is allowed to function as a delay memory of data communication so as to keep the process waiting, without using a so-called timer process.

However, when code conversion is unnecessary, received image data may be accumulated as is in the HDD, etc., so that a load on the system can be reduced. Accordingly, the same result as in the previously described embodiment can be achieved.

According to a previously described embodiment, the TNR signal stored in the transmission buffer unit 1302-2 is transmitted to the network in step S1604 in FIG. 17, so as to keep the transmission data waiting. In another embodiment, a wait process in a case where data received from an apparatus on the other end is stored in the reception buffer is described. The processing path of data received from the apparatus on the other end is the same as that illustrated in FIG. 11.

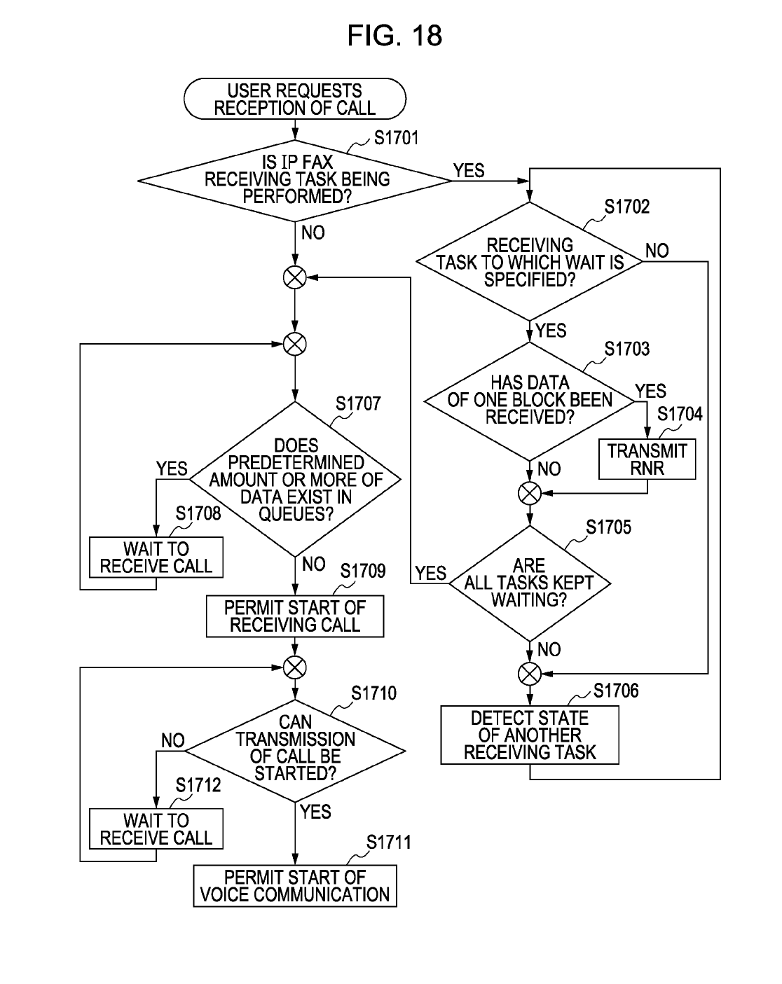

FIG. 18 is a flowchart illustrating an example of a sixth data communication process performed in a data communication apparatus according to the present embodiment. In this example, a receiving task to which wait is specified is performed. Each of the steps illustrated in FIG. 18 is realized when the controller 131 of the MFP 121 loads a control program from the ROM, etc. to the SDRAM and executes the program.

In the present embodiment, an RNR (Receive Not Ready) signal defined by ITU-T T.30 is transmitted to a transmitter on the other end as a wait process for reception data.

First, in step S1701, the controller 131 determines whether an IP FAX receiving task is being performed. If the controller 131 determines that an IP FAX receiving task is being performed, the process proceeds to step S1702, where the controller 131 determines whether the task is a receiving task for voice communication to which wait is specified. If the controller 131 determines that the task is not a receiving task to which wait is specified, the process proceeds to step S1706, where the controller 131 detects the state of another receiving task to which wait is specified but which is not kept waiting in the reception buffer in the SDRAM 46, and the process returns to step S1702.

On the other hand, if the controller 131 determines in step S1702 that the task is a receiving task to which wait is specified, the process proceeds to step S1703, where the controller 131 determines whether data of one block has been received. If the controller 131 determines that data of one block has been received, the controller 131 transmits the RNR signal stored in the reception buffer to the network in step S1704 and the process proceeds to step S1705.

On the other hand, if the controller 131 determines in step S1703 that data of one block has not been received, the process proceeds to step S1705, where the controller 131 determines whether all receiving tasks to which wait is specified are kept waiting. If the controller 131 determines that not all the tasks are kept waiting, the process proceeds to step S1706, where the controller 131 detects the state of another receiving task to which wait is specified but which is not kept waiting, and the process returns to step S1702.

On the other hand, if the controller 131 determines in step S1701 that an IP FAX receiving task is not being performed, the process proceeds to step S1707, where the controller 131 determines whether a predetermined amount or more of data to be received via the network is stored in the reception buffer. If the controller 131 determines that the predetermined amount or more of data is stored, the controller 131 keeps reception of voice data waiting in step S1708, and the process returns to step S1707.

On the other hand, if the controller 131 determines in step S1707 that the predetermined amount of reception data is not stored, the process proceeds to step S1709, where the controller 131 permits start of receiving the data stored in the reception buffer. Then, in step S1710, the controller 131 determines whether transmission of a call can be started in order to receive data from the apparatus on the other end via the network. If the controller 131 determines that transmission cannot be started, the controller 131 keeps reception of a call waiting in step S1712. Then, the process returns to step S1710.

On the other hand, if the controller 131 determines in step S1710 that transmission of a call can be started, the process proceeds to step S1711, where start of voice communication is permitted.

Accordingly, a process of transferring facsimile reception data stored in the reception buffer in the data communication apparatus can be kept waiting without using a timer process.

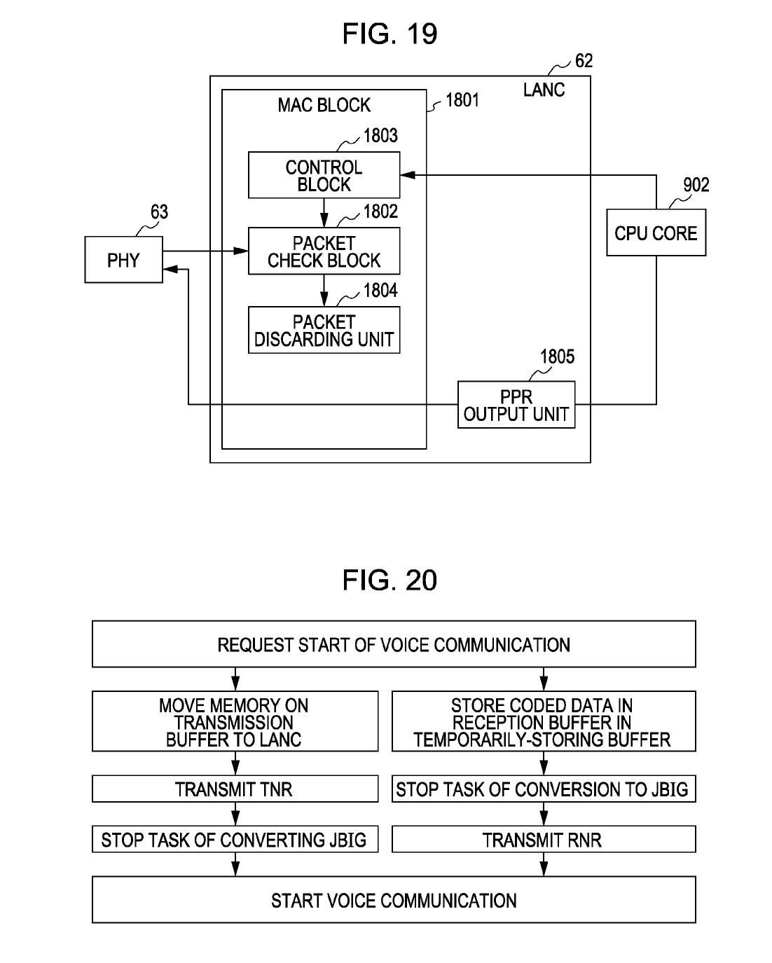

FIG. 19 is a block diagram illustrating a configuration of a main part of a data communication apparatus according to another embodiment of the present invention. In the present embodiment, a packet check block 1802 is provided in a MAC (Medium Access Control) block 1801 in the LANC 62 so as to perform filtering, and a packet is discarded. The parts that are the same as those in FIG. 9 are denoted by the same reference numerals.

In FIG. 19, the MAC block 1801 includes the packet check block 1802, a control block 1803, and a packet discarding unit 1804, which discards a packet received from the PHY 63. The packet discarding unit 1804 detects a specific reception packet, such as facsimile data, and discards the packet. Here, the PHY 63 is a physical layer IC controlling a physical layer of a network.

A PPR output unit 1805 transmits a PPR signal of ITU-T T.30 to an apparatus on the other end.

The packet discarding unit 1804 need not be provided in the MAC block 1801 or the LANC 62. For example, a configuration allowing a packet to be discarded when being transferred from the MAC block 1801 or the LANC 62 to a buffer or transferred from the buffer can be adopted. Also, a packet can be discarded without being transferred, or can be ignored after being transferred to the buffer. In these cases, too, the same advantage can be obtained.

A data reception path and a data transmission path via the network are the same as those illustrated in FIGS. 10 and 11. For example, in facsimile communication, a flow control is typically used. Thus, reception data can be retransmitted by an apparatus on the other end.

Processing a packet received by the MAC block 1801 via the PHY 63 downstream imposes a heavy load on the system, which can cause system failure. In such a case, a received packet is discarded by the packet discarding unit 1804.

According to the present embodiment, packets received by the data communication apparatus including a network interface controller, that is, the LANC 62, are checked, and a specific facsimile data packet is discarded. Accordingly, a load of voice data processing via the network in the data communication apparatus can be reduced.

In the previously described embodiment, packets received by the data communication apparatus including a network interface controller, that is, the LANC 62, are checked, and a specific facsimile data packet is discarded. In another exemplary embodiment, a facsimile receiving process can be recovered by requesting retransmission of a discarded specific facsimile data packet. Hereinafter, the present embodiment is described. The hardware configuration according to the present embodiment is the same as that illustrated in FIG. 19.

That is, packets received by the data communication apparatus including a network interface controller, that is, the LANC 62 illustrated in FIG. 19, are checked, and a specific facsimile data packet is discarded by the packet discarding unit 1804. After the packet has been discarded, a signal requesting retransmission is transmitted to an apparatus on the other end from the PPR output unit 1805.

In this way, after a predetermined amount of block data has been received, a signal requesting retransmission of the block data is transmitted to a transmitter on the other end. Accordingly, a facsimile receiving process can be normally recovered.

FIG. 20 illustrates an operation of a PPR output unit of a data communication apparatus according to another exemplary embodiment of the present invention. The PPR output unit has the same function as that illustrated in FIG. 19. In the present embodiment, before the data communication apparatus starts voice communication with another apparatus, the PPR output unit keeps data of a task other than a voice data communication task waiting.

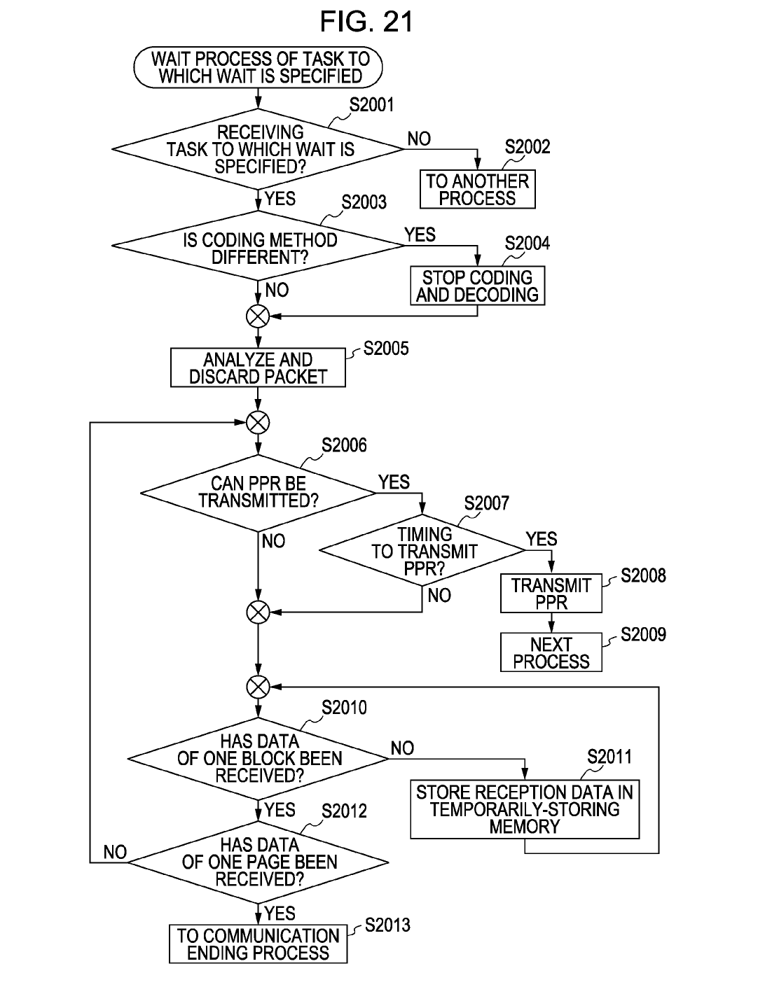

FIG. 21 is a flowchart illustrating an example of a seventh data communication process performed in the data communication apparatus according to the present embodiment. In the present embodiment, before the data communication apparatus starts voice communication with another apparatus, the PPR output unit keeps data of a task other than a voice data communication task waiting. Each of the steps illustrated in FIG. 21 is realized when the controller 131 of the MFP 121 loads a control program from the ROM, etc. to the SDRAM and executes the program.

First, in step S2001, the controller 131 determines whether wait is specified to the receiving task corresponding to the reception data held in the reception buffer 1301. If the controller 131 determines that wait is not specified to the receiving task, the process proceeds to step S2002, where another process is performed.

On the other hand, if the controller 1301 determines in step S2001 that wait is specified to the task, the process proceeds to step S2003, where the controller 131 determines whether the method for coding data accumulated in the reception buffer 1301 is different from that in the apparatus on the other end. If the controller 131 determines that the coding method is different, the process proceeds to step S2004, where coding and decoding are stopped, and the process proceeds to step S2005.

On the other hand, if the controller 131 determines in step S2003 that the coding method is the same, the process proceeds to step S2005, where packets are analyzed and discarded.

In step S2006, the controller 131 determines whether the PPR signal stored in the transmission buffer 1302 can be transmitted to the apparatus on the other end. If the controller 131 determines that the PPR signal can be transmitted, the controller 131 further determines in step S2007 whether the timing to transmit the PPR signal has come. If the controller 131 determines that the timing has come, the process proceeds to step S2008, where the PPR output unit 1805 transmits the PPR signal stored in the transmission buffer 1302 to the apparatus on the other end. Then, a next process is performed in step S2009.

On the other hand, if the controller 131 determines in step S2006 that the PPR signal cannot be transmitted to the apparatus on the other end, the process proceeds to step S2010. Likewise, if the controller 131 determines in step S2007 that the timing to transmit the PPR signal has not come, the process proceeds to step S2010.

In step S2010, the controller 131 determines whether data of one block has been received. The size of one block is predetermined.

If it is determined that data of one block has not been received, the process proceeds to step S2011, where the reception data stored in the reception buffer unit 1301-1 is stored in the temporarily-storing memory 1303, and the process returns to step S2010.

On the other hand, if it is determined in step S2010 that data of one block has been received, the process proceeds to step S2012, where the controller 131 determines whether data of one page has been received. If data of one page has been received, the process proceeds to step S2013, where a communication ending process is performed. If data of one page has not been received, the process returns to step S2006.

Accordingly, reception data for facsimile communication is accumulated as a queue in the reception buffer 1301 for accumulating data received from the network. At this time, the accumulated reception data can be temporarily stored in the temporarily-storing memory 1303, and wait control can be performed on a decoding process in the decoder 1304 in the subsequent stage. That is, by using the temporarily-storing memory 1303 as a delay memory of data communication instead of using a so-called timer process, wait control can be performed. Also, by using the delay memory function, an effect on voice data communication can be reduced even if data processing resources for data communication are limited.

Furthermore, reception of data for facsimile communication, which is kept waiting, can be restarted by transmitting the PPR signal.

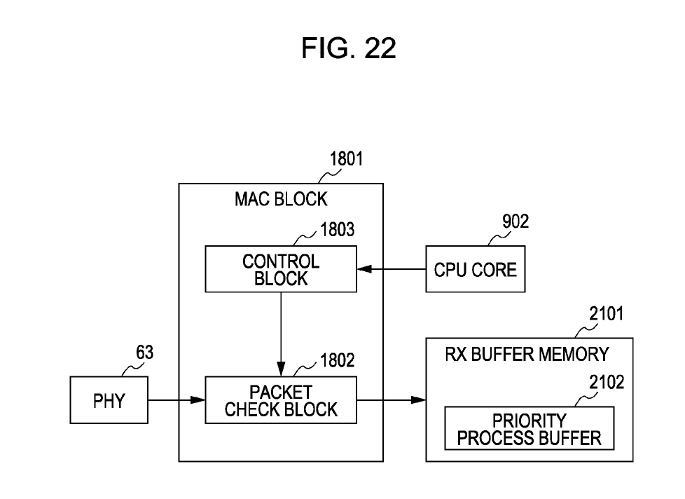

FIG. 22 is a block diagram illustrating a configuration of a main part of a data communication apparatus according to another exemplary embodiment of the present invention. In the present embodiment, a packet check function is provided in the MAC block 1801 and voice data is preferentially processed. The parts that are the same as those in FIG. 19 are denoted by the same reference numerals.

In FIG. 22, the packet check block 1802 is provided in the MAC block 1801 and preferentially processes voice data when detecting the voice data. A reception buffer memory 2101 is provided in the SDRAM 46. A priority process buffer 2102 stores voice data checked by the packet check block 1802. That is, the packet check block 1802 checks voice packets and transfers the packets to the priority process buffer 2102 functioning as a specific reception buffer to store data to be preferentially processed.

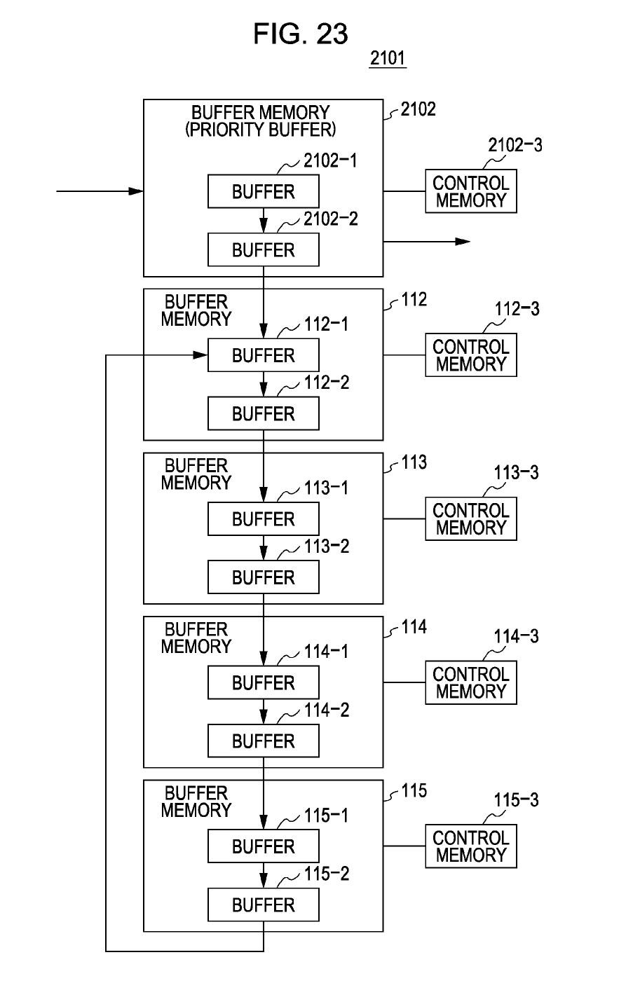

FIG. 23 is a block diagram illustrating a specific configuration of the entire reception buffer 2101 including the priority process buffer 2102 illustrated in FIG. 22. The parts that are the same as those in FIG. 4 are denoted by the same reference numerals. The priority process buffer 2102 includes internal buffers 2102-1 and 2102-2. In the present embodiment, data other than voice data is stored in the buffer memories 112 to 115, and the buffer memories 112 to 115 form a ring buffer.

In FIG. 23, a priority flag indicating that data communication is preferentially performed is provided in a control memory 2102-3. Voice data is transferred to the jitter absorbing buffer or the voice decoder with a higher priority than other received image data. In a data communication process, the priority process buffer 2102 may be fixed so that the data therein is preferentially processed.

According to the present embodiment, the LANC 62 determines whether data received via the network is voice data. If the received data is voice data, the voice data is transferred to the priority process buffer 2102, which is a specific area. The voice data in the priority process buffer 2102 can be transferred to the jitter absorbing buffer or the decoder with higher priority than facsimile reception data.

In a case where voice data is accumulated in the priority process buffer memory and is preferentially processed, a fixed area, for example, the priority process buffer 2102 may be used as the buffer memory to store the data that is preferentially processed. Alternatively, a priority order may be determined based on the specific flag provided in the control memory 2102-3.

Furthermore, if voice data is stored in a buffer while other communication data is transferred to the buffer, the transfer of the other communication data may be kept waiting. Accordingly, the voice data can be transferred with higher priority.

Specifically, a data communication process is performed in the following manner. That is, if voice data is accumulated in a buffer area to store voice data, transfer of data accumulated in other buffer areas is kept waiting. After the voice data has been transferred, transfer of the data in the other buffer areas is restarted.

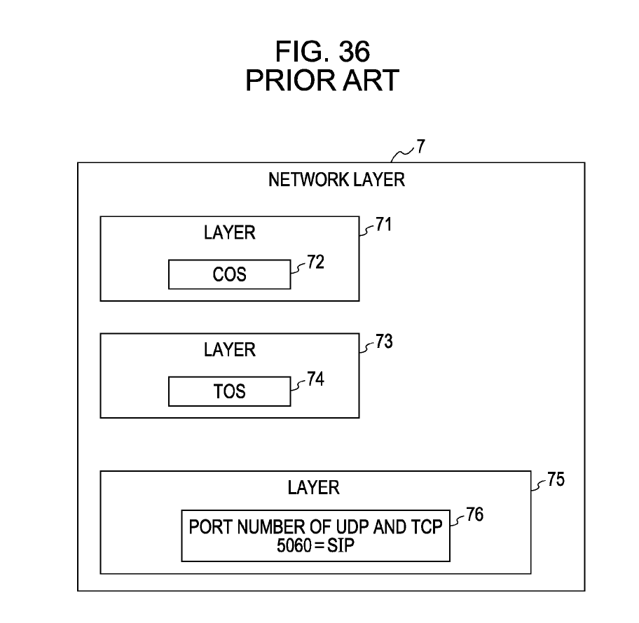

In the previously described embodiment, voice data communication is preferentially performed by storing a priority flag indicating that data communication is preferentially performed in the control memory 2102-3 illustrated in FIG. 23. Hereinafter, a case of using information of the COS (Class Of Service) field set in the field 72 of the layer 71 in the network layer illustrated in FIG. 36, instead of information of the priority flag, is described.

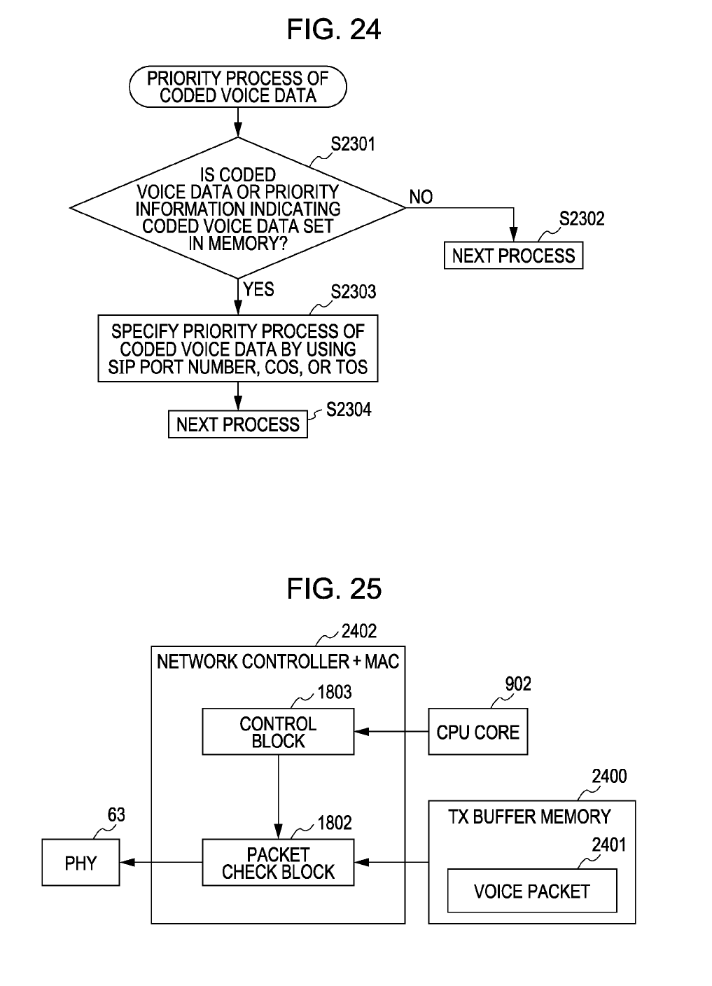

FIG. 24 is a flowchart illustrating an example of an eighth data communication process performed in a data communication apparatus according to another exemplary embodiment. In this example, a priority process is specified to a process of voice data based on the information of the COS field set in the field 72 of the layer 71. Each of the steps illustrated in FIG. 24 is realized when the controller 131 of the MFP 121 loads a control program from the ROM, etc. to the SDRAM and executes the program.

First, the controller 131 determines whether coded voice data or priority information indicating coded voice data is set in the memory. If the controller 131 determines that neither the voice data nor the information is set in the SDRAM 46, the process proceeds to step S2302.

In step S2303, a priority process is specified to the voice data to be preferentially processed by using information in the network layer, and a next process is performed in step S2304. Examples of the information in the network layer include an SIP port number, COS, and TOS (Type Of Service).

More specifically, in the example of the network layer illustrated in FIG. 36, in the field 72 of the layer 71, a COS field is used to identify a voice packet. In the field 74 of the layer 73, TOS is used to distinguish voice from data by an IP address. In an IP precedence field defined by RFC1349, high three bits are used as a field indicating priority. In DSCP (Differentiated Services Code Point) defined by RFC2474, high six bits of the TOS field are used to specify priority.

In the field 76 of the layer 75, a port number of TCP (Transmission Control Protocol) and UDP (User Datagram Protocol) is used. A representative application can be specified. When the port number is 5060, that means SIP, and thus a control signal of IP telephony can be preferentially processed.

Furthermore, information usable for a preferential process of a control signal of IP telephony includes RTP information, information of a voice coding method, and information of a voice coding method including G.711.

The data communication apparatus includes a network controller including a protocol control unit for protocols, such as TCP/IP, UDP, and RTP for performing network communication. The data communication apparatus extracts and preferentially processes coded voice data accumulated in the transmission buffer memory and transmits the data to the network by adding COS, TOS, and the port number 5060 of SIP to the data.

FIG. 25 is a block diagram illustrating a configuration of a main part of a data communication apparatus according to another exemplary embodiment of the present invention. In the present embodiment, a network controller to control a protocol signal and headers of packets is provided, and voice data accumulated in the buffer memory is preferentially processed. The parts that are the same as those in FIG. 22 are denoted by the same reference numerals.

In FIG. 25, a voice packet 2401 is stored in a transmission buffer memory 2400. A network controller 2402 has a function of a network controller and a function of the MAC block 1801. The network controller may have a CPU that is different from the CPU on the host side so as to control data communication.

In the present embodiment, after the packet check block 1802 has detected that information stored in the transmission buffer memory 2400 is the voice packet 2401, the network controller 2402 performs control to preferentially transmit the voice packet to the network. More specifically, after a packet to be transmitted has been generated, the packet check block 1802 checks the content of the packet and preferentially transmits the packet to the PHY 63.

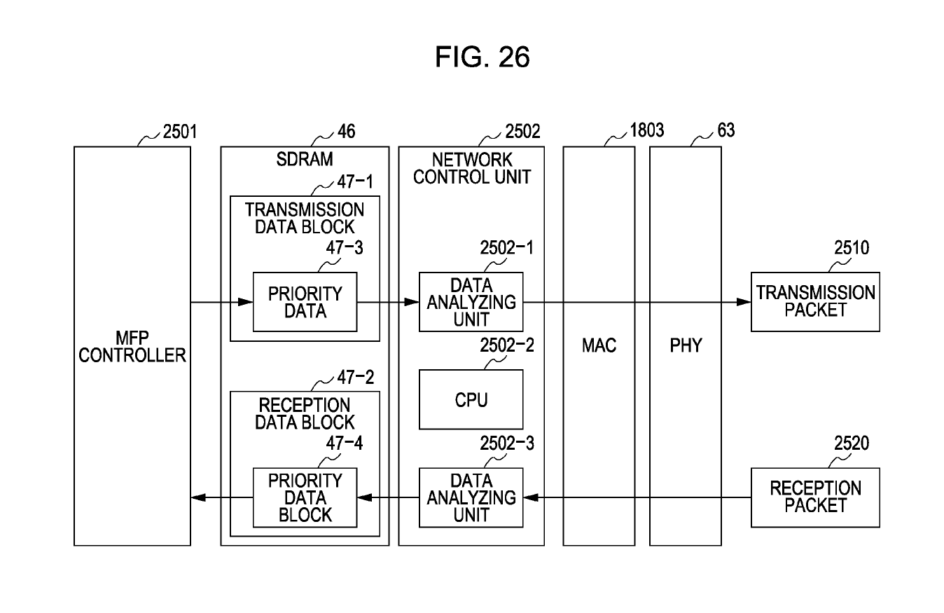

FIG. 26 is a block diagram illustrating a configuration of a main part of a data communication apparatus according to another exemplary embodiment of the present invention. In the present embodiment, generation of a header is performed by a network control unit, not by the CPU core on the host side. Also, COS information, TOS information, and the port number 5060 indicating SIP are used to preferentially process voice data. In FIG. 26, the parts that are the same as those in FIG. 22 are denoted by the same reference numerals.

In FIG. 26, a controller 2501 includes a CPU and so on. A transmission data block 47-1 can store priority data 47-3. A reception data block 47-2 includes a priority data block 47-4. An intelligent network control unit 2502 includes data analyzing units 2502-1 and 2502-3 and a CPU 2502-2. Reference numerals 2510 and 2520 denote a transmission packet and a reception packet, respectively.

In the present embodiment, the data analyzing unit 2502-1 analyzes the priority data 47-3 to control a priority process of voice data. As information used as the priority data 47-3, any of the COS information, TOS information, port number 5060 indicating SIP, RTP information, and information of voice coding method can be used.

According one of the previously described embodiments, the data communication apparatus includes the network controller including a protocol control unit for TCP/IP, UDP, and RTP to perform network communication. The network controller extracts and preferentially processes coded voice data accumulated in the transmission buffer memory, and transmits the data to the network by adding COS, TOS, and the port number 5060 of SIP to the data. Hereinafter, a packet process in a data communication apparatus on the receiver side is described.

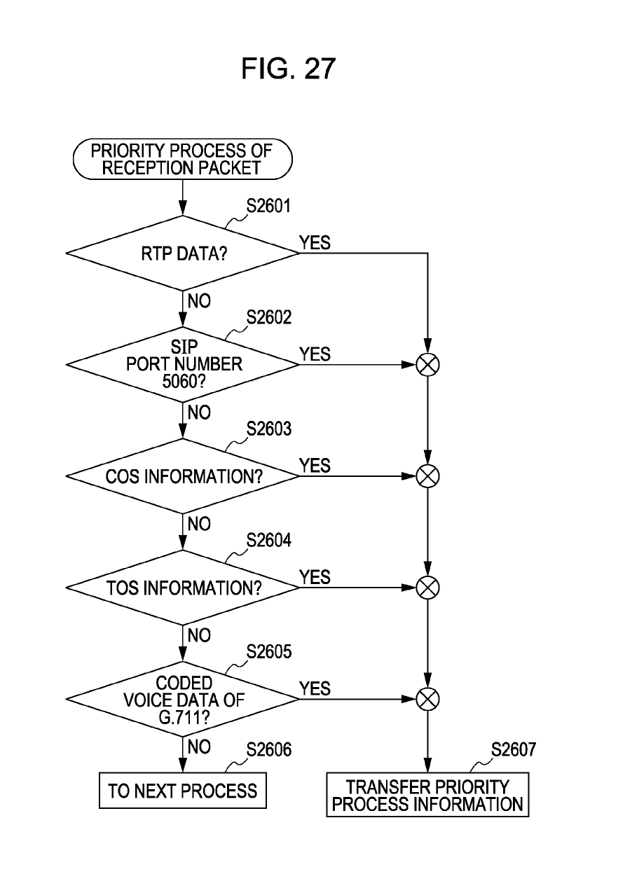

FIG. 27 is a flowchart illustrating an example of a ninth data communication process performed in a data communication apparatus according to another exemplary embodiment of the present invention. In the present embodiment, voice data received via a network is preferentially processed. Each of the steps illustrated in FIG. 27 is realized when the network controller of the MFP 121 loads a control program from the ROM, etc. to the SDRAM and executes the program.

The MAC block 1801 receives a packet via the PHY 63 and the packet check block 1802 determines whether information for preferentially processing voice data is added to the received packet.

First, in step S2601, the packet check block 1802 determines whether the reception packet is RTP data. If the packet check block 1802 determines that the reception packet is RTP data, the process proceeds to step S2607, where the RTP data is regarded as priority process information and is transferred to the priority process buffer 2102 of the reception buffer memory 2101.

On the other hand, if the packet check block 1802 determines in step S2601 that the reception packet is not RTP data, the process proceeds to step S2602, where the packet check block 1802 determines whether the reception packet is the port number 5060 of SIP. If the packet check block 1802 determines that the reception packet is the port number 5060 of SIP, the process proceeds to step S2607, where the port number 5060 of SIP is regarded as priority process information and is transferred to the priority process buffer 2102 of the reception buffer memory 2101.

On the other hand, if the packet check block 1802 determines in step S2602 that the reception packet is not the port number 5060 of SIP, the process proceeds to step S2603, where the packet check block 1802 determines whether the reception packet is COS information. If the packet check block 1802 determines that the reception packet is COS information, the process proceeds to step S2607, where the COS information is regarded as priority process information and is transferred to the priority process buffer 2102 of the reception buffer memory 2101.

On the other hand, if the packet check block 1802 determines in step S2603 that the reception packet is not COS information, the process proceeds to step S2604, where the packet check block 1802 determines whether the reception packet is TOS information. If the packet check block 1802 determines that the reception packet is TOS information, the process proceeds to step S2607, where the TOS information is regarded as priority process information and is transferred to the priority process buffer 2102 of the reception buffer memory 2101.

On the other hand, if the packet check block 1802 determines in step S2604 that the reception packet is not TOS information, the process proceeds to step S2605, where the packet check block 1802 determines whether the reception packet is coded voice data of G.711, etc. If the packet check block 1802 determines that the reception packet is coded voice data of G.711, etc., the process proceeds to step S2607, where the coded voice data of G.711, etc. is regarded as priority process information and is transferred to the priority process buffer 2102 of the reception buffer memory 2101.

On the other hand, if the packet check block 1802 determines in step S2605 that the reception packet is not coded voice data of G.711 or the like, the process proceeds to step S2606, where a next process is performed.

According to the present embodiment, the network controller including the protocol control unit for TCP/IP, UDP, and RTP to perform network communication picks up COS, TOS, RTP, and the port number 5060 of SIP in a packet from the network. By analyzing and preferentially processing the picked up COS, TOS, RTP, and the port number 5060 of SIP, the reception data can be preferentially stored in a memory.

Hereinafter, a priority process performed on transmission data in a data communication apparatus according to another exemplary embodiment of the present invention is described.

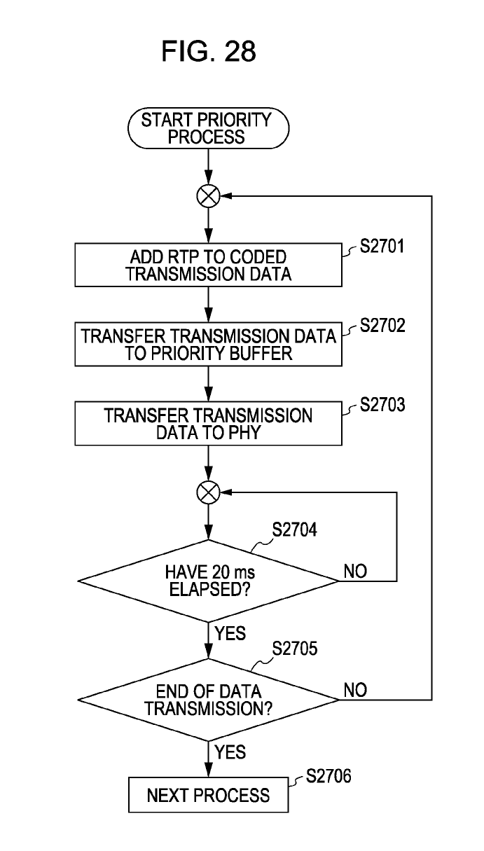

FIG. 28 is a flowchart illustrating an example of a tenth data communication process performed in the data communication apparatus according to the present embodiment. This example corresponds to a first example of a priority process of voice data received via a network. Each of the steps illustrated in FIG. 28 is realized when the LANC 62 of the MFP 121 loads a control program from the ROM, etc. to the SDRAM and executes the program.

First, the LANC 62 adds an RTP signal to coded transmission data in step S2701. In step S2702, the LANC 62 transfers the transmission data to the priority buffer 1302-2, the data in the priority buffer 1302-2 being processed with higher priority than transmission data of ITU-T T.37 stored in the transmission buffer unit 1302-1.

In step S2703, the LANC 62 transfers the transmission data transferred to the transmission buffer 1302 to the PHY 63 with higher priority than the transmission data of ITU-T T.37.

In step S2704, whether 20 ms have elapsed is determined through timer control. After 20 ms have elapsed, the process proceeds to step S2705, where the LANC 62 determines whether transmission of data has ended. If not ended, the process returns to step S2701.

On the other hand, if transmission of data has ended, the process proceeds to step S2706, where a next process is performed.

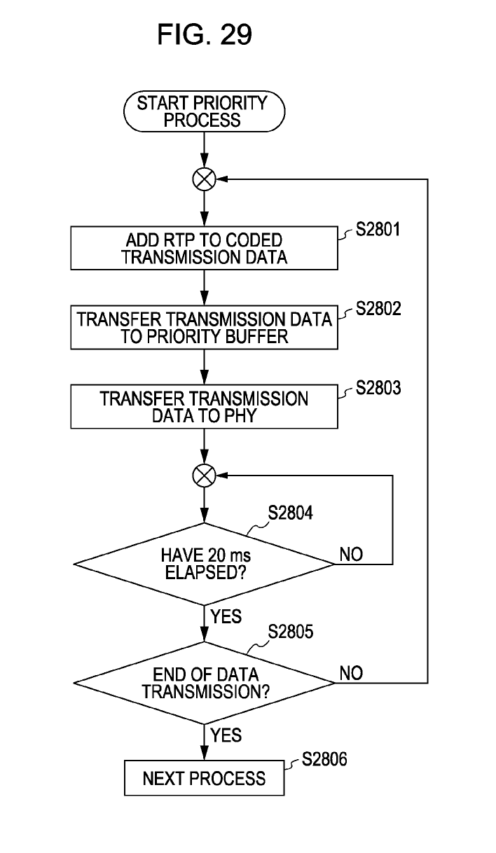

FIG. 29 is a flowchart illustrating an example of an eleventh data communication process performed in the data communication apparatus according to the present embodiment. This example corresponds to a second example of a priority process of voice data received via a network. Each of the steps illustrated in FIG. 29 is realized when the LANC 62 of the MFP 121 loads a control program from the ROM, etc. to the SDRAM and executes the program.

First, the LANC 62 adds an RTP signal to coded transmission data in step S2801. In step S2802, the LANC 62 transfers the transmission data to the priority buffer 1302-2, the data in the priority buffer 1302-2 being processed with higher priority than transmission data of ITU-T T.38 stored in the transmission buffer unit 1302-1.

In step S2803, the LANC 62 transfers the transmission data transferred to the transmission buffer 1302 to the PHY 63 with higher priority than the transmission data of ITU-T T.38.

In step S2804, whether 20 ms have elapsed is determined through timer control. After 20 ms have elapsed, the process proceeds to step S2805, where the LANC 62 determines whether transmission of data has ended. If not ended, the process returns to step S2801.

On the other hand, if transmission of data has ended, the process proceeds to step S2806, where a next process is performed.

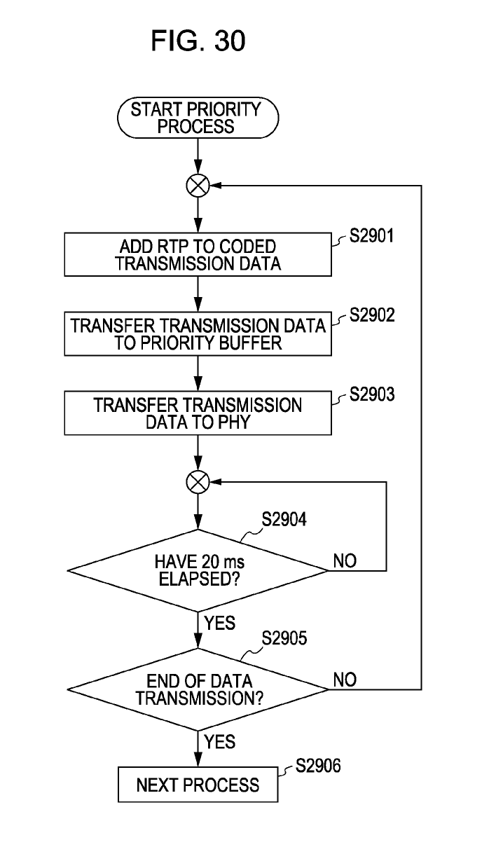

FIG. 30 is a flowchart illustrating an example of a twelfth data communication process performed in the data communication apparatus according to the present embodiment. This example corresponds to a third example of a priority process of voice data received via a network. Each of the steps illustrated in FIG. 30 is realized when the LANC 62 of the MFP 121 loads a control program from the ROM, etc. to the SDRAM and executes the program.

First, the LANC 62 adds an RTP signal to coded transmission data in step S2901. In step S2902, the LANC 62 transfers the transmission data to the priority buffer 1302-2, the data in the priority buffer 1302-2 being processed with higher priority than scan data that is stored in the transmission buffer unit 1302-1 and that is read by the scanner unit of the MFP.

In step S2903, the LANC 62 transfers the transmission data transferred to the transmission buffer 1302 to the PHY 63 with higher priority than the scan data.

In step S2904, whether 20 ms have elapsed is determined through timer control. After 20 ms have elapsed, the process proceeds to step S2905, where the LANC 62 determines whether transmission of data has ended. If not ended, the process returns to step S2901.

On the other hand, if transmission of data has ended, the process proceeds to step S2906, where a next process is performed.

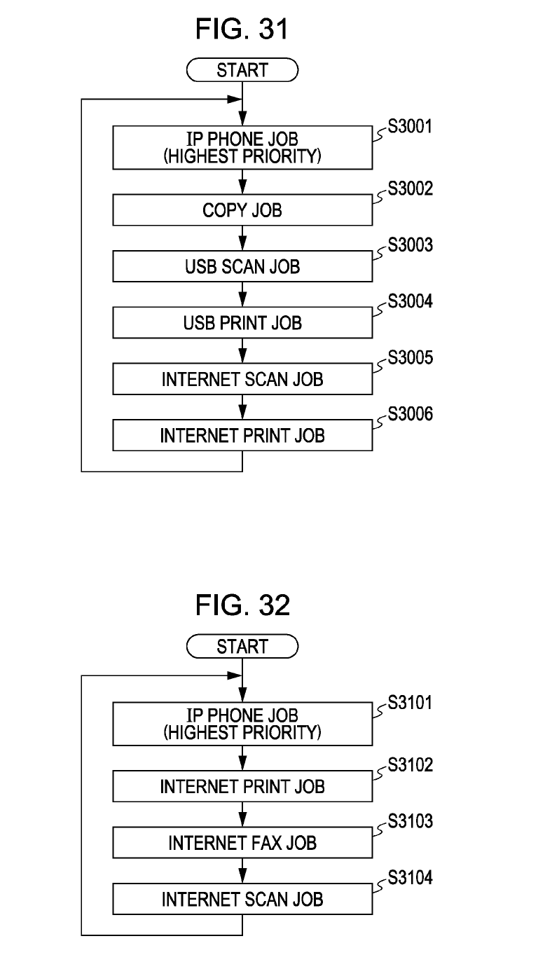

FIG. 31 is a flowchart illustrating an example of a thirteenth data communication process performed in the data communication apparatus according to the present embodiment. This example corresponds to a first example of a priority process performed on a voice communication job received via a network. Each of the steps illustrated in FIG. 31 is realized when the controller 131 of the MFP 121 loads a control program from the ROM or the like to the SDRAM and executes the program. In the present embodiment, an IP phone job, a copy job, a USB scan job, a USB print job, an Internet scan job, and an Internet print job are processed.

When there are jobs that can be processed in parallel, the controller 131 preferentially performs the IP phone job in step S3001. In step S3002, the controller 131 preferentially performs the copy job. In step S3003, the controller 131 preferentially performs the USB scan job. In step S3004, the controller 131 preferentially performs the USB print job. In step S3005, the controller 131 preferentially performs the Internet scan job. In step S3006, the controller 131 preferentially performs the Internet print job.

In this way, when competitive jobs of different attributes exist, the MFP including a data communication apparatus preferentially performs the IP phone job, and thus it can be prevented that a load is imposed on voice data communication.

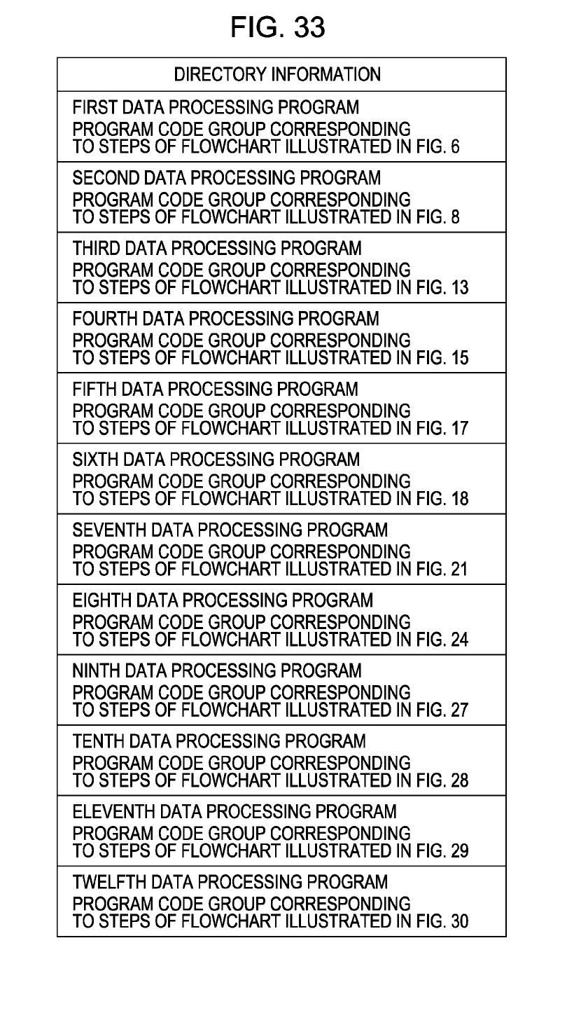

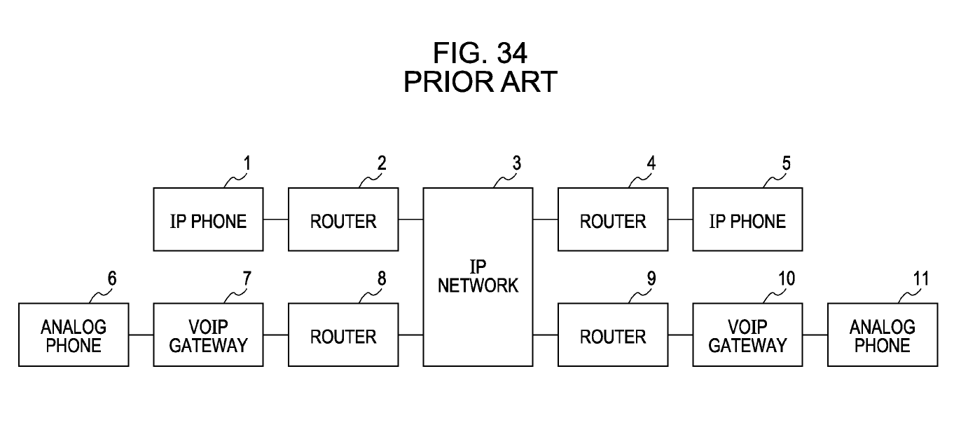

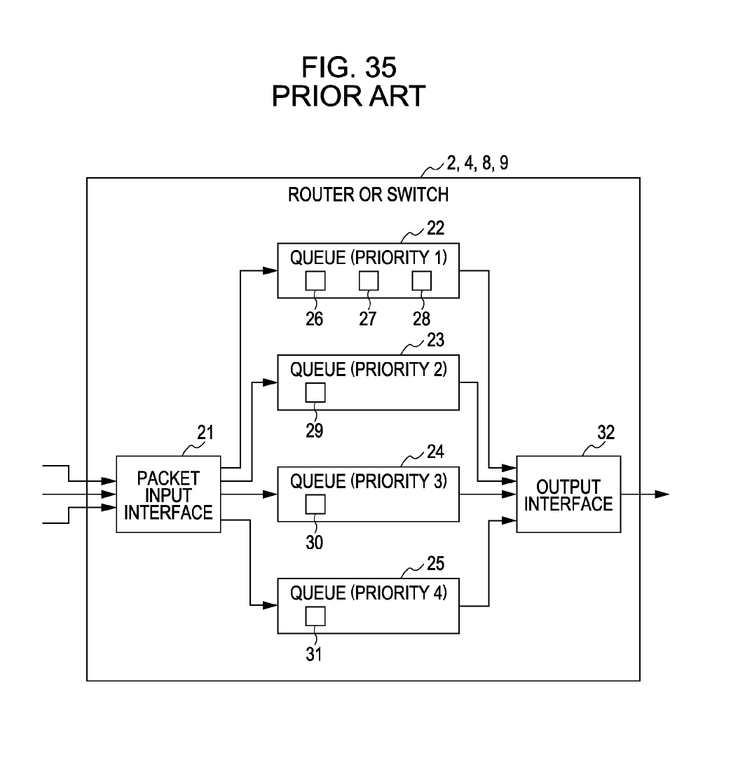

FIG. 32 is a flowchart illustrating an example of a fourteenth data communication process performed in the data communication apparatus according to the present embodiment. This example corresponds to a second example of a priority process performed on a voice communication job received via a network. Each of the steps illustrated in FIG. 32 is realized when the controller 131 of the MFP 121 loads a control program from the ROM, etc. to the SDRAM and executes the program.

When there are jobs that can be processed in parallel, the controller 131 preferentially performs the IP phone job in step S3101. In step S3102, the controller 131 preferentially performs the Internet print job. In step S3103, the controller 131 preferentially performs the Internet FAX job. In step S3104, the controller 131 preferentially performs the Internet scan job.

Accordingly, in a data communication apparatus capable of receiving print data via a network and printing the print data, voice data can be processed with higher priority than the print data.

Likewise, in a data communication apparatus capable of receiving print data from a digital camera via a USB interface and printing the print data, voice data can be transferred from/to a memory with higher priority than the print data.

Also, in a data communication apparatus capable of receiving print data from a host PC via a USB interface and printing the print data, voice data can be transferred from/to a memory with higher priority than the print data.

Furthermore, in a data communication apparatus capable of transferring scan data from a host PC via a USB interface, voice data can be transferred from/to a memory with higher priority than the scan data.

Also, in a data communication apparatus having a copy function, voice data can be transferred from/to a memory with higher priority than copy data.

Hereinafter, a configuration of data processing programs that can be read by the data communication apparatus according to the embodiments of the present invention is described with reference to the memory map illustrated in FIG. 33.

FIG. 33 illustrates the memory map of a storage medium storing the various data processing programs that can be read by the data communication apparatus according to the embodiments of the present invention. Although not shown, information managing a group of programs stored in the storage medium, for example, version information and the name of creator, is also stored. Furthermore, information depending on an OS (operating system) on the program reading side, for example, icons to identify the programs, may be stored.

Also, data depending on the various programs are managed in the directory. Also, a program to install the various programs to a computer and a program to decompress a compressed program may be stored.

The functions illustrated in FIGS. 6, 8, 13, 15, 17, 18, 21, 24, 27, 28, 29, and 30 may be executed by a host computer in accordance with programs installed from the outside. In that case, the present invention is applied even when a group of information including the programs is supplied to an output apparatus from a storage medium, such as a CD-ROM (compact disc read only memory), a flash memory, or an FD (floppy disk), or from an external storage medium via a network.

A storage medium containing a software program code realizing the functions of the above-described embodiments is supplied to a system or an apparatus. A computer (or CPU or MPU) of the system or the apparatus reads and executes the program code stored in the storage medium. Accordingly, the present invention can be carried out.

In that case, the program code read from the storage medium realizes a novel function of the present invention, and thus the storage medium storing the program code is included in the present invention. The form of the program is not specified as long as it has a function of a program. For example, an object code, a program executed by an interpreter, and script data supplied to the OS can be used.

Examples of the storage medium to supply programs include a floppy disk, a hard disk, an optical disc, a magneto-optical disc, a CD-ROM (compact disc read only memory), a CD-R (compact disc recordable), a CD-RW (compact disc rewritable), a magnetic tape, a nonvolatile memory card, a ROM, and a DVD (digital versatile disc). In this case, the program code read from the storage medium realizes the functions of the above-described embodiments, and the storage medium storing the program code is included in the present invention.

Alternatively, the program may be supplied in the following manner. That is, an Internet site is accessed by using a browser of a client computer. Then, the computer program of the present invention or a compressed file including an automatic install function is downloaded to a recording medium, such as a hard disk. Alternatively, the program code constituting the program of the present invention may be divided into a plurality of files, and the respective files may be downloaded from different sites. That is, a WWW server and an ftp server allowing a plurality of users to download a program file to realize the functions of the embodiments of the present invention in a computer are included in the present invention.

Alternatively, the programs of the present invention may be encrypted, stored in storage media such as CD-ROMs, and distributed to users. Among the users, the users satisfying a predetermined condition may be allowed to download key information to decrypt the programs from a site through the Internet. Then, the encrypted programs may be executed by using the key information and installed to a computer.

The functions of the above-described embodiments are realized when the computer executes the read program code. Alternatively, the functions of the above-described embodiments may be realized when an OS or the like operating in the computer executes part or all of actual processes based on instructions of the program code.

Furthermore, the functions of the above-described embodiments may be realized in the following way. That is, the program code read from the storage medium is written on a memory provided in a function expansion board inserted to the computer or a function expansion unit connected to the computer. Then, a CPU or the like provided in the function expansion board or the function expansion unit performs part or all of actual processes based on the instructions of the program code.

The present invention is not limited to the above-described embodiments, but various modifications (including an organic combination of the respective embodiments) can be carried out based on the scope of the present invention, and those modifications are not eliminated from the scope of the present invention.

While the present invention has been described with reference to exemplary embodiments, it is to be understood by those skilled in the art that the scope of the present invention is not limited to a specific description that is made in this specification.

This application claims the benefit of Japanese Application No. 2006-315449 filed Nov. 22, 2006, which is hereby incorporated by reference herein in its entirety.

What is claimed is:

1. A data communication apparatus that performs voice communication and facsimile communication in parallel via the Internet, the data communication apparatus comprising:
a buffer configured to store voice data about voice communication with another apparatus or facsimile data about facsimile communication with another apparatus, wherein the voice data and the facsimile data are transmitted or received via the Internet;
a deciding unit configured to determine whether the voice data is to be preferentially processed by determining a processing state of the voice data or the facsimile data stored in the buffer; and
a communication control unit configured to preferentially process the voice data stored in the buffer while maintaining the facsimile communication if the deciding unit determines to preferentially process the voice data stored in the buffer.

2. The data communication apparatus according to claim 1, wherein the communication control unit preferentially processes the voice data stored in the buffer by delaying beginning of processing the facsimile data stored in the buffer.

3. The data communication apparatus according to claim 1, wherein the buffer includes a plurality of buffer units of different priorities, and wherein the data communication apparatus further comprises
a transfer control unit configured to transfer the voice data to be stored in the buffer to a buffer unit of high priority from among the plurality of buffer units,
wherein the communication control unit preferentially processes the voice data transferred to the buffer unit of high priority.

4. The data communication apparatus according to claim 3, wherein the transfer control unit analyzes voice data received from the another apparatus via the Internet and transfers the received voice data to the buffer unit of high priority based on an analysis result.

5. A data communication apparatus that performs voice communication and facsimile communication in parallel via the Internet, the data communication apparatus comprising:
a reception buffer configured to store voice data about voice communication with another apparatus or facsimile data about facsimile communication with another apparatus, wherein the voice data and the facsimile data are received via the Internet;
a determining unit configured to determine whether a predetermined amount of the facsimile data is stored in the reception buffer; and
a communication control unit configured to restrict start of the voice communication if the determining unit determines that the predetermined amount of the facsimile data is stored in the reception buffer.

6. The data communication apparatus according to claim 5, further comprising:
a display unit configured to display a message to keep start of the voice communication waiting if the determining unit determines that the predetermined amount of the facsimile data is stored in the reception buffer.

7. A method in a data communication apparatus that performs voice communication and facsimile communication in parallel via the Internet, the method comprising:
determining whether voice data is to be preferentially processed by determining a processing state of the voice data about voice communication with another apparatus or facsimile data about facsimile communication with another apparatus, wherein the voice data and the facsimile data are stored in a buffer of the data communication apparatus; and
preferentially processing the voice data stored in the buffer while maintaining the facsimile communication if it is determined to preferentially process the voice data.

8. The method according to claim 7, wherein the voice data stored in the buffer is preferentially processed by delaying beginning of processing the facsimile data stored in the buffer.

9. The method according to claim 7, wherein the voice data to be stored in the buffer is transferred to a buffer unit of high priority from among a plurality of buffer units of different priorities included in the buffer, and wherein the voice data transferred to the buffer unit of high priority is preferentially processed.

10. The method according to claim 9, wherein voice data received from the another apparatus via the Internet is analyzed and the received voice data is transferred to the buffer unit of high priority based on an analysis result.

11. A method in a data communication apparatus that performs voice communication and facsimile communication in parallel via the Internet, the method comprising:
determining whether a predetermined amount of facsimile data is stored in a reception buffer that stores voice data about voice communication with another apparatus or facsimile data about facsimile communication with another apparatus; and
restricting beginning of the voice communication if it is determined that the predetermined amount of the facsimile data is stored in the reception buffer.

12. The method according to claim 11, wherein a message to keep start of the voice communication waiting is displayed in a display unit if it is determined that the predetermined amount of the facsimile data is stored in the reception buffer.
